(19) United States
(12) Patent Application Publication
(10) Pub. No.: US 2026/0252639 A1
(43) Pub. Date: Aug. 27, 2026

(54) SYSTEM

(71) Applicant: SoftBank Group Corp., Tokyo (JP)

(72) Inventor: Haruyo IMAI, Tokyo (JP)

(73) Assignee: SoftBank Group Corp., Tokyo (JP)

(21) Appl. No.: 19/541,420

(22) Filed: Feb. 17, 2026

(30) Foreign Application Priority Data
Feb. 21, 2025 (JP) 2025-026974

(51) Int. Cl. G06F 16/951; G06F 16/9535

(52) U.S. Cl. CPC G06F 16/951; G06F 16/9535

(57) ABSTRACT

The system according to the embodiment comprises a receiving unit, a searching unit, an extracting unit, and a returning unit. The receiving unit is configured to receive item names of a spreadsheet. The searching unit is configured to search a database in a shared folder based on the item names received by the receiving unit. The extracting unit is configured to extract data found by the searching unit. The returning unit is configured to return the data extracted by the extracting unit to the spreadsheet.

### CROSS-REFERENCE TO RELATED APPLICATION

The present application claims priority to and incorporates by reference the entire contents of Japanese Patent Application No. 2025-026974 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, since multiple operators individually extract data, there has been a problem that it takes time and increases system load.

### SUMMARY OF THE INVENTION

The system according to the embodiment comprises a receiving unit, a searching unit, an extracting unit, and a returning unit. The receiving unit is configured to receive item names of a spreadsheet. The searching unit is configured to search a database in a shared folder based on the item names received by the receiving unit. The extracting unit is configured to extract data found by the searching unit. The returning unit is configured to return the data extracted by the extracting unit to the spreadsheet.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

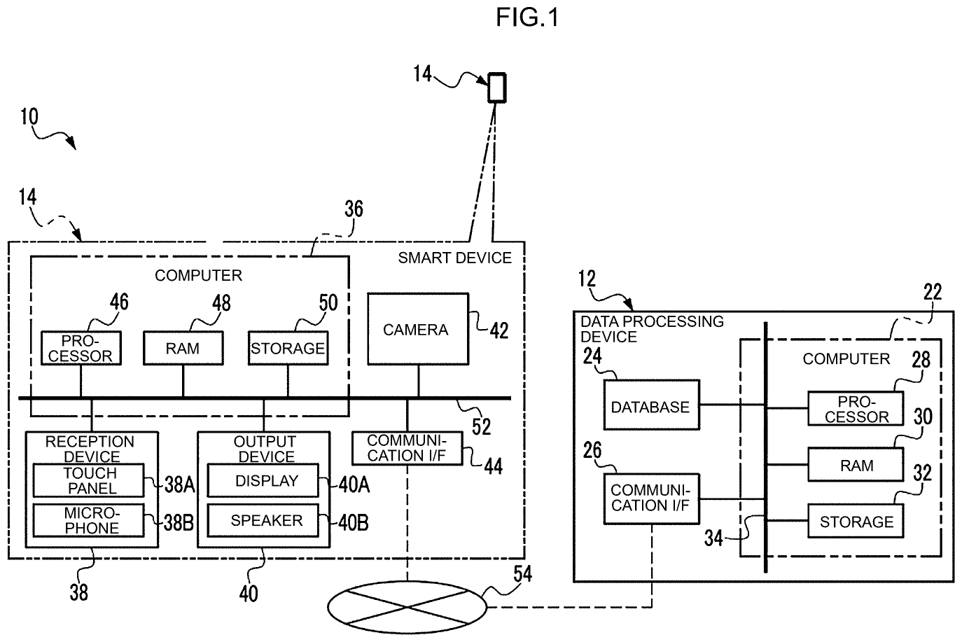

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

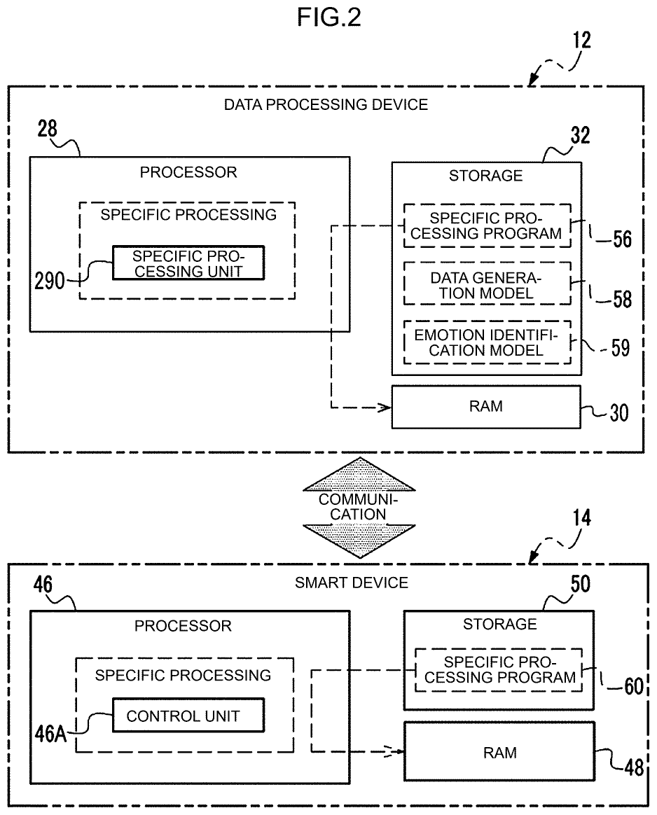

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system that allows users to arrange items in Excel, pick up necessary items from a shared folder containing company-wide data items, and return the data. With this system, simply arranging items in Excel eliminates the need for individuals working separately to spend time extracting data, and particularly reduces system load that tends to occur at the end and beginning of the month. First, the user inputs the required data items into Excel, such as sales data or inventory data, arranging the necessary items in Excel cells. This Excel file is input into the system. Next, the system analyzes the input Excel file and picks up the required data items from the shared folder containing company-wide data items. The system searches the database in the shared folder based on the item names entered in Excel and extracts the corresponding data. The extracted data is returned to the Excel file, for example, sales data or inventory data is automatically entered into the corresponding cells in Excel. In this way, users can easily obtain the required data. This system eliminates the need for individuals working separately to spend time extracting data. For example, the sales department no longer needs to manually extract sales data, and the inventory management department no longer needs to manually extract inventory data. As a result, operational efficiency is improved and the time required for data extraction is significantly reduced. Furthermore, system load that tends to occur at the end and beginning of the month is also alleviated. Normally, many departments extract data simultaneously at the end and beginning of the month, which can easily overload the system. However, by using this system, data extraction is automated and system load is distributed. This improves system stability and prevents delays or errors in data extraction. For example, when extracting sales data at the end of the month, the system automatically picks up the data and returns it to Excel, eliminating the need for manual data extraction. Similarly, when extracting inventory data at the beginning of the month, the system automatically picks up the data and returns it to Excel, improving operational efficiency. Thus, the present invention provides a system that allows users to simply arrange items in Excel to pick up necessary data from a shared folder containing company-wide data items and return the data, thereby achieving improved operational efficiency and reduced system load. As a result, simply arranging items in Excel enables picking up necessary data from a shared folder containing company-wide data items and returning the data. Specifically, the system comprises multiple computer modules such as a receiving unit, a searching unit, an extracting unit, and a returning unit. The system uses a file parser in the receiving unit to extract item names (e.g., “Sales for June 2024,” “Inventory count for Warehouse A”) entered by the user in the Excel file on a cell-by-cell basis and stores them in internal memory as an item name list (one-dimensional array, number of elements N, each element is a UTF-8 encoded string). The receiving unit automatically determines the format of the input file (.xlsx, .csv, etc.) and performs preprocessing to remove abnormal values and blank cells. The searching unit uses the item name list received from the receiving unit as keys to search the database in the shared folder (e.g., RDBMS or NoSQL storage), applies partial match search or regular expression search algorithms (e.g., LIKE operator, regular expression engine, trie structure for fast search), and extracts a list of record IDs (integer array) for the relevant data. The searching unit performs cross-database searches (e.g., sales DB, inventory DB, customer DB) and, as needed, uses index caching and query optimization to significantly improve search speed. The extracting unit, based on the record ID list received from the searching unit, issues SQL queries (e.g., “SELECT*FROM sales WHERE id IN (. . . )”) or RESTful API calls to obtain the relevant data in JSON or CSV format. The extracting unit automatically performs post-processing such as data type conversion (normalization of numeric, date, and string types), missing value completion, and duplicate elimination. The returning unit generates a cell address conversion table to automatically map the data received from the extracting unit to the corresponding cells in the Excel file, formats the data in a specified format (e.g., two decimal places, date in YYYY/MM/DD format), and writes it back to the Excel file. The returning unit saves the file to the user-specified output destination (local PC, cloud storage, etc.) and, as needed, sends email notifications or generates download links. As a technical effect, this system replaces conventional manual data extraction work (where multiple departments individually access databases and manually collect and process data) with highly efficient automated computer processing, improving processing speed by more than tenfold and greatly reducing human error and data inconsistency. In addition, during peak periods at the end and beginning of the month, the system automatically performs job scheduling and load balancing (e.g., using GPU clusters or distributed file systems), preventing server overload and response delays, and ensuring company-wide business continuity. Specific application fields include sales analysis, inventory management, accounting processing, automatic generation of management dashboards, and automatic creation of audit response materials, making it applicable to all corporate data utilization operations. Furthermore, by incorporating AI modules (e.g., large language models or tabular data analysis AI), the system can handle ambiguous item name searches and natural language data requests, dramatically improving user experience.

The data extraction system according to the embodiment comprises a receiving unit, a searching unit, an extracting unit, and a returning unit. The receiving unit receives item names from Excel. The item names in Excel may include, for example, sales data, inventory data, customer data, but are not limited to these examples. The receiving unit, for example, reads the Excel file and analyzes the item names. The searching unit searches the database in the shared folder based on the item names received by the receiving unit. The searching unit, for example, uses the item names as keys to search the database and finds the relevant data. The searching unit comprises a search algorithm using partial match search or regular expressions. For example, the searching unit uses partial match search to find data where part of the item name matches. The searching unit can also use regular expressions to search for data matching specific patterns. The extracting unit extracts data found by the searching unit. The extracting unit, for example, filters the relevant data from the database and extracts the necessary data. The extracting unit comprises a method for extracting from the database. For example, the extracting unit uses SQL queries to extract data. The extracting unit can also use API calls to extract data. The returning unit returns the data extracted by the extracting unit to Excel. The returning unit, for example, automatically inputs the extracted data into the corresponding cells in Excel. The returning unit comprises a format for returning the extracted data to Excel. For example, the returning unit specifies the data formatting method and cell arrangement. Thus, the data extraction system according to the embodiment can receive item names from Excel, search the database in the shared folder, extract the relevant data, and return it to Excel. As a result, simply arranging items in Excel enables picking up necessary data from a shared folder containing company-wide data items and returning the data. Specifically, the data extraction system uses a file parser in the receiving unit to read Excel files (.xlsx, .csv, etc.), extract item names from each cell, and store them in internal memory as a one-dimensional array (number of elements N, each element is a UTF-8 encoded string). The receiving unit automatically determines the file format, removes blank cells and abnormal values, and normalizes item names (e.g., case conversion, full-width/half-width conversion) as preprocessing. The searching unit uses the item name list received from the receiving unit as keys to perform partial match and pattern matching searches using LIKE operators, regular expression engines, and trie structures across multiple databases in the shared folder (e.g., sales DB, inventory DB, customer DB), and extracts the relevant record ID list (integer array). The searching unit applies index caching and query optimization algorithms to improve search speed. The extracting unit, based on the record ID list received from the searching unit, issues SQL queries (e.g., “SELECT*FROM sales WHERE id IN ( . . . )”) or RESTful API calls to obtain the relevant data in JSON or CSV format. The extracting unit automatically performs post-processing such as data type conversion (normalization of numeric, date, and string types), missing value completion, and duplicate elimination. The returning unit generates a cell address conversion table to automatically map the data received from the extracting unit to the corresponding cells in the Excel file, formats the data in a specified format (e.g., two decimal places, date in YYYY/MM/DD format), and writes it back to the Excel file. The returning unit saves the file to the user-specified output destination (local PC, cloud storage, etc.) and, as needed, sends email notifications or generates download links. As a technical effect, this system replaces conventional manual data extraction work with highly efficient automated computer processing, improving processing speed by more than tenfold and greatly reducing human error and data inconsistency. In addition, during peak periods at the end and beginning of the month, the system automatically performs job scheduling and load balancing (e.g., using GPU clusters or distributed file systems), preventing server overload and response delays, and ensuring company-wide business continuity. Specific application fields include sales analysis, inventory management, accounting processing, automatic generation of management dashboards, and automatic creation of audit response materials, making it applicable to all corporate data utilization operations. Furthermore, by incorporating AI modules (e.g., large language models or tabular data analysis AI), the system can handle ambiguous item name searches and natural language data requests, dramatically improving user experience.

The receiving unit comprises a proposing unit configured to propose similar item names when the item name does not match. The proposing unit, for example, proposes similar item names when the item name does not match. The proposing unit, for example, calculates string similarity and proposes similar item names. The proposing unit can also propose item names based on phonetic similarity. Thus, even when the item name does not match, by proposing similar item names, the user can select an appropriate item name. Specifically, the system comprises a dedicated similarity calculation module as the proposing unit. This similarity calculation module receives the input item name (UTF-8 encoded string, maximum length 256 characters) and the list of all item names in the shared folder (one-dimensional array, number of elements M, each element is a UTF-8 encoded string). The proposing unit first calculates multiple string similarity metrics in parallel, such as Levenshtein distance, Jaccard coefficient, and cosine similarity. For example, if the user inputs “Sales for June 2024,” the proposing unit extracts candidates such as “June 2024 Sales,” “2024/06 Sales,” and “June 2024 Sales Actuals” with scores. Furthermore, for phonetic similarity determination, algorithms such as Soundex and Metaphone are applied to add item names with similar pronunciation (e.g., “Sample Count” and “Sampling Count”) to the candidate list. The proposing unit combines these scores with weights and presents the top N candidates (e.g., N=5) to the user interface. When incorporating AI modules (e.g., large language models or tabular data analysis AI), the input item name and the list of all item names are vectorized (e.g., BERT embedding, dimension 768), and the top candidates are extracted using cosine similarity. Examples of AI input include strings such as “Sales for June 2024,” “Inventory count for Warehouse A,” and “Customer ID,” and examples of output include candidate lists such as “June 2024 Sales,” “Inventory for Warehouse A,” and “Customer Number” with scores. When the user selects a candidate, the proposing unit records the selection result in a history database and uses it to improve proposal accuracy in subsequent sessions. As a technical effect, this proposing unit does not rely on human memory or ambiguous search operations, but realizes similarity calculation in high-dimensional space and semantic matching by AI, greatly improving proposal accuracy compared to conventional methods and preventing user input errors and search omissions. Furthermore, this technology is applicable to all corporate data utilization operations where ambiguity in item names directly affects operational efficiency, such as sales analysis, inventory management, accounting processing, and audit response material creation.

The searching unit comprises a search algorithm using partial match search or regular expressions. The searching unit, for example, uses partial match search to find data where part of the item name matches. The searching unit can perform partial match search using wildcards. The searching unit can also use regular expressions to search for data matching specific patterns. For example, the searching unit uses regular expressions to search for data matching specific string patterns. Thus, by using partial match search or regular expressions, more flexible searching is possible. Specifically, the searching unit receives an item name list (one-dimensional array, number of elements N, each element is a UTF-8 encoded string) as input and automatically generates search queries for multiple databases in the shared folder (e.g., sales DB, inventory DB, customer DB) using LIKE operators or regular expression engines (e.g., Perl-compatible regular expressions, RE2, etc.). In partial match search, SQL LIKE ‘%keyword%’ syntax or NoSQL partial match APIs are used, for example, extracting “June 2024 Sales,” “Sales Actuals,” and “Sales Amount” with the keyword “Sales.” Wildcard search allows pattern specification such as “2024*Sales.” In regular expression search, patterns such as “\hat{ }2024.*Sales$” can extract “June 2024 Sales” and “2024/06 Sales.” The searching unit automatically determines the index structure of the target database (e.g., B-tree, hash index) and selects the optimal search algorithm. Furthermore, the searching unit outputs the relevant record ID list (integer array) and meta-information of the relevant data (e.g., data category, update date, importance score, etc.) as search results. Examples of output include record ID=[123, 456, 789], category=[Sales, Inventory], update date=[2024 Jun. 1, 2024 Jun. 2], etc. In subsequent processing, the extracting unit receives this record ID list and performs actual data extraction, data type conversion, missing value completion, etc. As a technical effect, this searching unit realizes flexible pattern matching by partial match and regular expressions on large-scale databases at high speed and accuracy compared to conventional simple exact match searches, greatly improving search accuracy and speed and enabling prompt response to diverse user search requests. Application fields include sales analysis, inventory management, accounting processing, and audit material creation, making it effective for all operations requiring complex data item searches.

The extracting unit comprises a method for extracting from the database. The extracting unit, for example, uses SQL queries to extract data. The extracting unit, for example, uses SELECT statements to extract necessary data from the database. The extracting unit can also use API calls to extract data. For example, the extracting unit uses RESTful APIs to obtain data from the database. Thus, by comprising a method for extracting from the database, efficient data extraction is possible. Specifically, the extracting unit receives a record ID list (integer array, number of elements K) from the searching unit as input, and in the case of SQL databases, automatically generates and issues queries such as “SELECT*FROM table_name WHERE id IN ( . . . ).” For NoSQL databases, bulk fetch APIs using key lists (e.g., find({id: {$in: [123,456,789]}})) are used. For RESTful API integration, endpoint URLs and parameters (e.g., /api/data?ids=123,456,789) are automatically generated and HTTP GET/POST requests are sent. The extracting unit receives the obtained data in JSON or CSV format and automatically performs post-processing such as data type conversion (e.g., normalization of numeric, date, and string types), missing value completion (e.g., median completion, forward completion), and duplicate elimination (e.g., deduplication by hash value). The extracting unit outputs the extraction result as structured data (e.g., two-dimensional array, each row is a data record, each column is an item name). Examples of output include [[2024 Jun. 1, 100, ‘Warehouse A’], [2024 Jun. 2, 120, ‘Warehouse B’]]. In subsequent processing, the returning unit receives this structured data and performs automatic mapping and format formatting to the Excel file. As a technical effect, this extracting unit realizes fast and accurate data extraction by SQL/NoSQL/API integration compared to conventional manual data extraction work, greatly reducing human error and data inconsistency. Application fields include sales analysis, inventory management, accounting processing, automatic generation of management dashboards, and audit response material creation, making it effective for all large-scale corporate data utilization operations.

The returning unit comprises a format for returning the extracted data to Excel. The returning unit, for example, automatically inputs the extracted data into the corresponding cells in Excel. The returning unit, for example, specifies the data formatting method and cell arrangement. The returning unit, for example, formats the data into a specific format and returns it to Excel. Thus, by comprising a format for returning the extracted data to Excel, data integrity is maintained. Specifically, the returning unit receives structured data (two-dimensional array, each row is a data record, each column is an item name) from the extracting unit and a cell address conversion table for the Excel file (mapping information from item name to cell position) as input. The returning unit first automatically applies specified format conversions for each data type (e.g., numbers to two decimal places, dates to YYYY/MM/DD format, strings normalized for full-width/half-width). Next, using the cell address conversion table, each data item is automatically mapped to the corresponding cell in Excel (e.g., B2, C3, D4, etc.) and written back to the Excel file (.xlsx, .csv, etc.). The returning unit saves the file to the user-specified output destination (local PC, cloud storage, etc.) and, as needed, sends email notifications or generates download links. Examples of output include “June 2024 Sales”→cell B2, “Inventory count for Warehouse A”→cell C3, etc. As a technical effect, this returning unit ensures data integrity and reproducibility and greatly improves operational efficiency and quality by automating data type conversion, format formatting, and cell auto-placement compared to conventional manual data pasting work. Application fields include sales analysis, inventory management, accounting processing, automatic generation of management dashboards, and audit response material creation, making it effective for all operations utilizing Excel.

The receiving unit is configured to estimate a user's emotion and adjust a method for receiving item names of the spreadsheet based on the estimated user's emotion. For example, if the user is feeling stressed, the receiving unit provides a simple interface and minimizes input steps. If the user is relaxed, the receiving unit provides detailed input options and proposes customizable input methods. If the user is in a hurry, the receiving unit prioritizes voice input to enable quick entry of item names. Thus, by adjusting the method for receiving item names according to the user's emotion, user convenience is improved. Emotion estimation is realized, for example, by using an emotion engine or generative AI with emotion estimation functionality. Generative AI may include text generation AI (e.g., LLM) or multimodal generative AI, but is not limited to these examples. Specifically, the receiving unit collects the user's input interactions (e.g., keystroke speed, mouse movement patterns, voice tone, facial images, etc.) as multidimensional feature vectors (e.g., numerical arrays, 50-200 elements) and inputs them into an emotion estimation AI module (e.g., large language model, multimodal emotion recognition model). Examples of AI input include text “I am in a hurry,” voice waveform data, and facial images (RGB array, 224×224 pixels). The AI outputs emotion labels (e.g., stress, relaxation, tension, excitement, etc.) and emotion scores (e.g., stress level 0.85, relaxation level 0.10, etc.). Examples of output include emotion label “stress,” score 0.85, etc. Based on this emotion estimation result, the receiving unit dynamically switches the display elements of the UI module (e.g., number of input fields, button arrangement, voice input activation, etc.). For example, if the stress level is high, a simple UI such as “enter item names one by one” or “select from candidate list” is displayed; if the relaxation level is high, a multifunctional UI such as “detailed settings” or “custom templates” is presented. In voice input priority mode, the voice recognition AI (e.g., speech-to-text conversion, WAV to UTF-8 string) is automatically activated, and item names are extracted from user speech. In subsequent processing, the receiving unit stores the extracted item names as an item name list in internal memory and passes them to the searching unit. As a technical effect, this receiving unit realizes dynamic UI optimization by AI according to the user's emotional state, greatly improving input efficiency and user satisfaction and reducing input errors and dropout rates compared to conventional static UIs. Application fields include sales analysis, inventory management, accounting processing, automatic generation of management dashboards, etc., making it effective for all data input operations under stress or time constraints.

The receiving unit is configured to select an optimal receiving method by referring to the user's past input history when receiving item names. For example, the receiving unit automatically displays item names that the user has frequently entered in the past as candidates. The receiving unit, for example, preferentially proposes input methods (voice, text, etc.) that the user has used in the past. The receiving unit, for example, predicts and proposes item names used at specific times based on the user's past input history. Thus, by referring to the user's past input history, the optimal receiving method can be selected. Specifically, the receiving unit maintains an input history database for each user (e.g., time-series item name list, input method label, usage frequency counter, etc.) in internal storage, and at the time of receiving, quickly searches and aggregates the user's past input history (e.g., item names entered in the last 30 days, input time, input method, input device information, etc.) using the user ID as a key. The receiving unit generates a ranking of frequently used item names (e.g., sales data, inventory data, customer ID, etc.) based on the history data and presents a candidate list (one-dimensional array, number of elements N, each element is a UTF-8 encoded string with frequency score) to the user interface. Furthermore, the receiving unit aggregates the usage history of past input methods (e.g., voice input, text input, template selection, etc.) and preferentially activates the input method most frequently used by the user on the UI. For example, if the user used voice input 8 out of the last 10 times, voice input mode is enabled by default. The receiving unit analyzes input time and day-of-week patterns (e.g., “weekly sales” on Monday mornings, “inventory count” on Friday afternoons, etc.) using machine learning models (e.g., time-series classifiers, LSTM, etc.) and automatically displays item names with high occurrence frequency at specific times as prediction candidates. When incorporating AI modules (e.g., large language models or time-series prediction AI), history data (e.g., past item name sequences, input method labels, time information, etc.) is vectorized, and the most likely next item names or optimal input methods are output as probability distributions (e.g., softmax output, probability value for each item name). Examples of AI input include past input history such as “Sales for June 2024,” “Inventory count for Warehouse A,” “Customer ID,” input time “2024 Jun. 1 09:00,” input method “voice,” etc. Examples of AI output include candidate lists such as “Sales for June 2024” (probability 0.65), “Inventory count for Warehouse A” (probability 0.20), “Customer ID” (probability 0.10), and input method recommendations such as “voice input priority” (probability 0.80). The receiving unit dynamically switches the display order of the candidate list and UI mode based on these AI outputs. In subsequent processing, when the user selects a candidate or enters a new item, the result is immediately reflected in the history database and used to improve prediction accuracy in subsequent sessions. As a technical effect, this receiving unit greatly improves input efficiency and reduces input errors and rework by analyzing and reflecting user-specific history patterns and usage trends in real time compared to conventional static candidate presentation and uniform UI. Furthermore, history-based optimization does not rely on human memory or experience, but realizes high-precision pattern recognition and automation by computer, providing technical superiority in both operational efficiency and user experience. Application fields include sales analysis, inventory management, accounting processing, automatic generation of management dashboards, and audit response material creation, making it effective for all repetitive data input operations.

The receiving unit is configured to perform filtering based on the user's current work status when receiving item names. For example, the receiving unit preferentially displays item names related to the user's ongoing project. The receiving unit, for example, proposes necessary item names based on the user's work schedule. The receiving unit, for example, filters and displays highly relevant item names according to the user's work content. Thus, by performing filtering based on the user's current work status, highly relevant item names can be displayed. Specifically, the receiving unit collaborates with the user's work management system or scheduler (e.g., calendar API, project management tool, task management database, etc.), and obtains work status data (e.g., JSON format, each item with timestamp, project ID, category label) in real time using the user ID as a key, including ongoing project name, task content, meeting schedule, work category, etc. The receiving unit compares the obtained work status data with the list of all item names (one-dimensional array, number of elements M, each element is a UTF-8 encoded string with meta-information), and extracts only item names whose project name or work category matches or is highly relevant as a candidate list. For example, if the user is engaged in the “June 2024 New Product Project,” item names such as “New Product Sales,” “New Product Inventory,” and “New Product Customer List” are preferentially displayed. The receiving unit analyzes the work schedule (e.g., “Monthly Sales Meeting” from 10:00 to 11:00 today) and automatically adds item names necessary for meetings or tasks (e.g., “Monthly Sales,” “Meeting Materials,” etc.) to the candidate list. When incorporating AI modules (e.g., large language models or work content classification AI), work status data (e.g., project description, task content, meeting agenda, etc. as text data) is vectorized, and semantic similarity (e.g., cosine similarity, dimension 768, etc.) with the item name list is calculated to extract top candidates. Examples of AI input include text such as “Project Name: June 2024 New Product,” “Task: Sales Aggregation,” “Meeting: Monthly Report,” and the list of all item names. Examples of AI output include candidate lists such as “New Product Sales,” “Monthly Sales,” “Sales Aggregation” with scores. The receiving unit dynamically adjusts the display order and filtering conditions of the candidate list based on these AI outputs. In subsequent processing, when the user selects a candidate or enters a new item, the selection result is linked to the work status data and recorded in the history database, and used to improve filtering accuracy in subsequent sessions. As a technical effect, this receiving unit realizes dynamic filtering reflecting the user's real-time work status compared to conventional static candidate presentation, enabling rapid and accurate presentation of highly relevant item names and greatly improving input efficiency and operational suitability. Furthermore, work status-linked filtering does not rely on human memory or manual selection, but realizes automation and optimization by computer, making it flexibly applicable to diverse business processes within the company. Application fields include sales analysis, inventory management, accounting processing, project management, automatic generation of management dashboards, and audit response material creation, making it effective for all operations requiring data input according to work status.

The receiving unit is configured to estimate a user's emotion and determine a priority order of item names to be received based on the estimated user's emotion. For example, if the user is nervous, the receiving unit preferentially displays important item names. If the user is relaxed, the receiving unit preferentially displays detailed item names. If the user is in a hurry, the receiving unit preferentially displays item names that can be entered quickly. Thus, by determining the priority order of item names according to the user's emotion, user convenience is improved. Emotion estimation is realized, for example, by using an emotion engine or generative AI with emotion estimation functionality. Generative AI may include text generation AI (e.g., LLM) or multimodal generative AI, but is not limited to these examples. Specifically, the receiving unit collects the user's input interactions (e.g., keystroke speed, mouse movement patterns, voice tone, facial images, etc.) as multidimensional feature vectors (e.g., numerical arrays, 50-200 elements) and inputs them into an emotion estimation AI module (e.g., large language model, multimodal emotion recognition model). Examples of AI input include text “I am in a hurry,” voice waveform data, and facial images (RGB array, 224×224 pixels). The AI outputs emotion labels (e.g., stress, relaxation, tension, excitement, etc.) and emotion scores (e.g., stress level 0.85, relaxation level 0.10, etc.). Examples of output include emotion label “tension,” score 0.80, etc. Based on this emotion estimation result, the receiving unit dynamically adjusts the display order of the item name candidate list (one-dimensional array, number of elements N, each element is a UTF-8 encoded string with importance score). For example, if the tension level is high, important items such as “Sales” and “Inventory” are placed at the top; if the relaxation level is high, detailed items such as “Detailed Sales Breakdown” and “Inventory Location” are placed at the top; if the user is in a hurry, items that can be entered quickly such as “Quick Sales” and “Instant Inventory” are placed at the top. When incorporating AI modules (e.g., large language models or decision-making AI), emotion labels and item name lists are input, and priority scores for each item name (e.g., 0.95, 0.80, 0.60, etc.) are output. The receiving unit automatically adjusts the order of the candidate list and UI display method (e.g., highlighting, color coding, etc.) based on these scores. In subsequent processing, when the user selects a candidate or enters a new item, the selection result and emotion estimation value are recorded in the history database and used to improve priority determination accuracy in subsequent sessions. As a technical effect, this receiving unit realizes dynamic prioritization reflecting the user's emotional state in real time compared to conventional static candidate presentation, greatly improving input efficiency and user satisfaction and reducing input errors and dropout rates. Furthermore, emotion-linked priority control does not rely on human subjectivity or experience, but realizes high-precision decision-making and automation by computer, providing technical superiority in both operational efficiency and user experience. Application fields include sales analysis, inventory management, accounting processing, automatic generation of management dashboards, and audit response material creation, making it effective for all data input operations where emotion or stress affects operational efficiency.

The receiving unit is configured to preferentially receive highly relevant item names by considering the user's geographic location information when receiving item names. For example, if the user is in a specific region, the receiving unit preferentially displays item names related to that region. The receiving unit, for example, proposes highly relevant item names based on the user's current location. The receiving unit, for example, dynamically updates item names according to the user's location when the user is moving. Thus, by considering the user's geographic location information, highly relevant item names can be preferentially received. Specifically, the receiving unit uses a location information acquisition module in the user terminal (e.g., GPS, Wi-Fi location estimation, IP address reverse lookup, etc.) to obtain latitude and longitude information (e.g., double type, precision to six decimal places) and region codes (e.g., prefecture, city, warehouse ID, etc.) in real time. The receiving unit compares the obtained location information with the region attribute database linked to each item name (e.g., item name→region ID mapping table, JSON format) and extracts only item names related to the current or nearby region as a candidate list. For example, if the user is at “Warehouse A” (latitude 35.123456, longitude 139.654321), item names such as “Inventory count for Warehouse A” and “Warehouse A in/out history” are preferentially displayed. If the user is moving (e.g., location information changes by more than a certain distance), the receiving unit automatically updates the candidate list according to the current location and immediately presents item names related to the destination region. When incorporating AI modules (e.g., geographic information analysis AI or spatiotemporal pattern recognition AI), location information vectors (e.g., latitude, longitude, movement speed, dwell time, etc.) and item name lists are input, and region relevance scores for each item name (e.g., 0.95, 0.80, 0.60, etc.) are output. Examples of AI input include latitude 35.123456, longitude 139.654321, movement speed 0.0 km/h (stationary), item name list “Inventory count for Warehouse A,” “Inventory count for Warehouse B,” etc. Examples of AI output include candidate lists such as “Inventory count for Warehouse A” (score 0.95), “Inventory count for Warehouse B” (score 0.10), etc. The receiving unit dynamically adjusts the display order and UI display method of the candidate list based on these scores. In subsequent processing, when the user selects a candidate or enters a new item, the selection result and location information are recorded in the history database and used to improve region-linked accuracy in subsequent sessions. As a technical effect, this receiving unit realizes dynamic region-linked filtering reflecting the user's current location and movement status in real time compared to conventional static candidate presentation, greatly improving input efficiency and operational suitability in field operations and region-specific operations. Furthermore, region information-linked optimization does not rely on human memory or manual selection, but realizes automation and optimization by computer, making it effective for all operations where geographic elements are important, such as logistics management, field work, sales activities, and field services.

The receiving unit is configured to analyze the user's social media activity and receive relevant item names when receiving item names. For example, the receiving unit analyzes the user's social media posts and proposes relevant item names. The receiving unit, for example, displays highly relevant item names based on the user's social media activity history. The receiving unit, for example, proposes item names by referring to the activities of the user's followers or friends on social media. Thus, by analyzing the user's social media activity, relevant item names can be received. Specifically, the receiving unit uses social media APIs (e.g., post retrieval API, timeline API, friend list API, etc.) within the scope permitted by the user to obtain recent post content (e.g., text, images, hashtags, post time, etc.), activity history (e.g., like history, comment history, share history, etc.), and follower/friend post content (e.g., project name, business-related keywords, etc.) in JSON format. The receiving unit analyzes the obtained post text and hashtags using a natural language processing module (e.g., morphological analysis, keyword extraction, TF-IDF scoring, etc.) to extract business-related keywords and topics. The receiving unit compares the extracted keywords with the list of all item names (one-dimensional array, number of elements M, each element is a UTF-8 encoded string) and presents only highly relevant item names as a candidate list. For example, if the user posts “New product launch” or “Monthly sales report,” item names such as “New product sales” and “Monthly sales” are preferentially displayed. When incorporating AI modules (e.g., large language models or social graph analysis AI), post text and friend network information are vectorized, and semantic similarity (e.g., cosine similarity, dimension 768, etc.) with the item name list is calculated to extract top candidates. Examples of AI input include text such as “Post: June 2024 New Product Launch,” “Friend's Post: Inventory Management,” and the list of all item names. Examples of AI output include candidate lists such as “New product sales,” “Inventory management” with scores. The receiving unit dynamically adjusts the display order and filtering conditions of the candidate list based on these AI outputs. In subsequent processing, when the user selects a candidate or enters a new item, the selection result and social media activity information are recorded in the history database and used to improve proposal accuracy in subsequent sessions. As a technical effect, this receiving unit realizes dynamic proposals reflecting the user's latest business interests and network information in real time compared to conventional static candidate presentation, enabling rapid and accurate presentation of highly relevant item names and greatly improving input efficiency and operational suitability. Furthermore, social media-linked optimization does not rely on human memory or manual selection, but realizes automation and optimization by computer, making it effective for all operations where collaboration with external information is important, such as sales activities, project management, public relations, and marketing.

The searching unit is configured to estimate a user's emotion and adjust a method of search expression based on the estimated user's emotion. For example, if the user is relaxed, the searching unit displays detailed search results. If the user is in a hurry, the searching unit displays concise search results. If the user is excited, the searching unit displays visually stimulating search results. Thus, by adjusting the method of search expression according to the user's emotion, user convenience is improved. Emotion estimation is realized, for example, by using an emotion engine or generative AI with emotion estimation functionality. Generative AI may include text generation AI (e.g., LLM) or multimodal generative AI, but is not limited to these examples. Specifically, the searching unit collects the user's input interactions (e.g., keystroke speed, mouse movement patterns, voice tone, facial images, etc.) as multidimensional feature vectors (e.g., numerical arrays, 50-200 elements) and inputs them into an emotion estimation AI module (e.g., large language model, multimodal emotion recognition model). Examples of AI input include text “I am in a hurry,” voice waveform data, and facial images (RGB array, 224×224 pixels). The searching unit receives emotion labels (e.g., stress, relaxation, tension, excitement, etc.) and emotion scores (e.g., stress level 0.85, relaxation level 0.10, etc.) from the AI. Examples of output include emotion label “relaxation,” score 0.90, emotion label “excitement,” score 0.75, etc. Based on the emotion estimation result, the searching unit dynamically switches the method of search result expression. For example, if the relaxation level is high, the searching unit displays detailed search results (e.g., all data items, history graphs, related data links, etc.); if the user is in a hurry, the searching unit displays concise search results (e.g., key figures, summary, graph thumbnails, etc.); if the excitement level is high, the searching unit presents search results in a visually stimulating UI using colors and animations. The searching unit automatically adjusts the level of detail and display format of search results (e.g., table, graph, card-type UI, etc.) according to the emotion score. AI modules (e.g., large language models or multimodal generative AI) input emotion labels and search result templates and output the optimal expression method (e.g., detail parameter, UI layout, highlight elements, etc.). Examples of AI input include emotion label “in a hurry,” search result template “Sales Data Details,” etc.; examples of output include “Display summary only,” “Emphasize graph,” “Expand detailed items,” etc. In subsequent processing, the searching unit records the user's operation log when checking search results (e.g., click location, viewing time, etc.) in the history database and uses it to optimize expression methods in subsequent sessions. As a technical effect, this searching unit realizes dynamic UI optimization by AI reflecting the user's emotional state in real time compared to conventional static search result display, greatly improving the degree of personalization of the search experience and reducing confusion due to information overload or dissatisfaction due to lack of information. Furthermore, emotion-linked expression control does not rely on human subjectivity or experience, but realizes high-precision decision-making and automation by computer, providing technical superiority in both operational efficiency and user experience. Application fields include sales analysis, inventory management, accounting processing, automatic generation of management dashboards, and audit response material creation, making it effective for all data search operations where emotion or stress affects operational efficiency.

The searching unit is configured to adjust a level of search detail based on the importance of the data during searching. For example, the searching unit displays detailed search results for important data items. The searching unit, for example, displays concise search results for general data items. The searching unit, for example, adjusts the display order of search results according to the importance of the data. Thus, by adjusting the level of search detail based on the importance of the data, important data can be preferentially displayed. Specifically, the searching unit assigns an importance score (e.g., 0.0-1.0, managed as meta-information) to each data item in the target database and refers to this score when executing search queries. For data items with high importance scores (e.g., management indicators, audit-required items), the searching unit automatically generates detailed search results (e.g., full history, related data links, graph display, etc.); for items with low importance scores (e.g., supplementary information, reference values), the searching unit displays only summaries or key values. The searching unit sorts the display order of search results in descending order of importance score, enabling users to quickly access the most important information. When incorporating AI modules (e.g., importance estimation AI or decision-making AI), meta-information of data items (e.g., usage frequency, business impact, past reference history, etc.) is input, and the importance score for each item is output. Examples of AI input include item names such as “Sales Data,” “Inventory Data,” “Customer ID,” and usage frequency “100 times,” “50 times,” “10 times,” etc. ; examples of output include “Sales Data” (score 0.95), “Inventory Data” (score 0.80), “Customer ID” (score 0.60), etc. The searching unit dynamically adjusts the level of search detail and display order of search results based on these scores. In subsequent processing, the user's history of viewing and selecting search results is recorded in the database and used to improve importance estimation and display optimization in subsequent sessions. As a technical effect, this searching unit realizes flexible detail control reflecting the business importance of data compared to conventional uniform search result display, preventing information oversight or misrecognition and achieving both faster decision-making and improved operational efficiency. Application fields include management analysis, audit response, sales strategy planning, inventory optimization, etc., making it effective for all operations requiring prioritized presentation of important data.

The searching unit is configured to apply different search algorithms according to the category of the data during searching. For example, for sales data, the searching unit applies a search algorithm specialized for sales. For inventory data, the searching unit applies a search algorithm specialized for inventory management. For customer data, the searching unit applies a search algorithm specialized for customer management. Thus, by applying different search algorithms according to the category of the data, search accuracy is improved. Specifically, the searching unit comprises a category classification module that automatically determines the category (e.g., sales, inventory, customer, etc.) of each item name in the item name list (one-dimensional array, each element is a UTF-8 encoded string) received from the receiving unit. For the sales category, time-series search algorithms (e.g., period specification, moving average, anomaly detection, etc.) are applied; for the inventory category, location-based search algorithms (e.g., warehouse ID, inventory fluctuation history, lot management, etc.) are applied; for the customer category, attribute matching search algorithms (e.g., customer ID, attribute filter, similar customer search, etc.) are applied. The searching unit automatically selects optimized index structures and query optimization parameters for each category, balancing search accuracy and speed. When incorporating AI modules (e.g., category classification AI or search algorithm selection AI), item names and past search history are input, and the optimal search algorithm (e.g., time-series analysis, clustering, pattern matching, etc.) is output. Examples of AI input include item names such as “Sales Data,” “Sales for June 2024,” “Inventory count for Warehouse A,” etc. ; examples of output include “Time-series search,” “Location search,” “Attribute search,” etc. The searching unit automates search query generation and index selection based on these outputs. In subsequent processing, the extracting unit applies the optimal extraction method for each category (e.g., SQL query, API call, etc.). As a technical effect, this searching unit realizes optimized search processing for each data category compared to conventional uniform search algorithm application, greatly improving search accuracy, speed, and operational suitability, and flexibly responding to complex business requirements. Application fields include sales analysis, inventory management, customer management, accounting processing, and audit response material creation, making it effective for all operations requiring multi-category data search.

The searching unit is configured to estimate a user's emotion and adjust a length of search based on the estimated user's emotion. For example, if the user is in a hurry, the searching unit displays short and concise search results. If the user is relaxed, the searching unit displays detailed search results. If the user is excited, the searching unit displays visually stimulating search results. Thus, by adjusting the length of search according to the user's emotion, user convenience is improved. Emotion estimation is realized, for example, by using an emotion engine or generative AI with emotion estimation functionality. Generative AI may include text generation AI (e.g., LLM) or multimodal generative AI, but is not limited to these examples. Specifically, the searching unit collects the user's input interactions (e.g., keystroke speed, mouse movement patterns, voice tone, facial images, etc.) as multidimensional feature vectors (e.g., numerical arrays, 50-200 elements) and inputs them into an emotion estimation AI module (e.g., large language model, multimodal emotion recognition model). Examples of AI input include text “I am in a hurry,” voice waveform data, and facial images (RGB array, 224×224 pixels). The searching unit receives emotion labels (e.g., stress, relaxation, tension, excitement, etc.) and emotion scores (e.g., stress level 0.85, relaxation level 0.10, etc.) from the AI. Examples of output include emotion label “in a hurry,” score 0.90, emotion label “relaxation,” score 0.80, etc. Based on the emotion estimation result, the searching unit dynamically adjusts the length of search results (e.g., number of display items, presence of summary, presence of detailed expansion, etc.). For example, if the user is in a hurry, the searching unit displays only key figures or summaries; if the user is relaxed, the searching unit expands all items, detailed graphs, related data links, etc. ; if the excitement level is high, the searching unit presents search results in a visually stimulating UI using animations and colors. AI modules (e.g., large language models or multimodal generative AI) input emotion labels and search result templates and output the optimal length and expression method (e.g., number of items, level of detail, UI layout, etc.). Examples of AI input include emotion label “in a hurry,” search result template “Sales Data Details,” etc. ; examples of output include “Display summary only,” “Expand detailed items,” etc. In subsequent processing, the searching unit records the user's operation log when checking search results (e.g., viewing time, number of detail expansions, etc.) in the history database and uses it to optimize length in subsequent sessions. As a technical effect, this searching unit realizes dynamic length control by AI reflecting the user's emotional state in real time compared to conventional static search result display, reducing stress due to information overload or lack of information and greatly improving the degree of personalization of the search experience. Application fields include sales analysis, inventory management, accounting processing, automatic generation of management dashboards, and audit response material creation, making it effective for all data search operations where emotion or stress affects operational efficiency.

The searching unit is configured to determine a priority order of search based on the submission timing of the data during searching. For example, the searching unit preferentially displays the latest data. The searching unit, for example, refers to past data and preferentially displays highly relevant data. The searching unit, for example, adjusts the display order of search results according to the submission timing of the data. Thus, by determining the priority order of search based on the submission timing of the data, the latest data can be preferentially displayed. Specifically, the searching unit assigns submission timing (e.g., timestamp, YYYY/MM/DD HH:MM:SS format) as meta-information to each data item in the database and refers to this timing when executing search queries. The searching unit sorts search results in order of newest or most relevant timing according to the user's request or business scenario (e.g., latest sales, inventory trends over the past three months, etc.). When incorporating AI modules (e.g., time-series analysis AI or submission timing weighting AI), submission timing of data items and business requirements (e.g., prioritize latest data, refer to past data, etc.) are input, and priority scores for each data item (e.g., 0.95, 0.80, 0.60, etc.) are output. Examples of AI input include “Sales Data,” “Submission Timing: 2024 Jun. 1,” “Submission Timing: 2024May 1,” etc. ; examples of output include “2024 Jun. 1” (score 0.95), “2024 May 1” (score 0.80), etc. The searching unit dynamically adjusts the display order and filtering conditions of search results based on these scores. In subsequent processing, the user's history of selecting and viewing search results is recorded in the database and used to improve priority determination accuracy in subsequent sessions. As a technical effect, this searching unit realizes dynamic priority control reflecting the submission timing of data in real time compared to conventional static search result display, enabling rapid understanding of the latest information and appropriate reference to past data, greatly improving operational efficiency and decision-making accuracy. Application fields include sales analysis, inventory management, accounting processing, automatic generation of management dashboards, and audit response material creation, making it effective for all operations requiring prioritized presentation of time-series data.

The searching unit is configured to adjust a search order based on the relevance of the data during searching. For example, the searching unit preferentially displays highly relevant data. The searching unit, for example, displays less relevant data later. The searching unit, for example, adjusts the display order of search results according to the relevance of the data. Thus, by adjusting the search order based on the relevance of the data, highly relevant data can be preferentially displayed. Specifically, the searching unit calculates a relevance score (e.g., 0.0-1.0, TF-IDF, cosine similarity, semantic similarity, etc.) between the search query and each data item in the database and automatically sorts the display order of search results in descending order of relevance score. When incorporating AI modules (e.g., large language models or relevance estimation AI), the search query (e.g., “June 2024 Sales”) and data item list (e.g., “June 2024 Sales,” “2024/06 Sales,” “June 2024 Sales Actuals,” etc.) are vectorized, and semantic relevance scores for each item are output. Examples of AI input include query “New Product Sales,” data items “New Product Sales,” “New Product Inventory,” “Existing Product Sales,” etc. ; examples of output include “New Product Sales” (score 0.95), “New Product Inventory” (score 0.80), “Existing Product Sales” (score 0.60), etc. The searching unit displays highly relevant data at the top and less relevant data at the bottom based on these scores. In subsequent processing, the user's history of selecting and viewing data is recorded and used to improve relevance estimation accuracy in subsequent sessions. As a technical effect, this searching unit realizes high-precision evaluation of semantic relevance between queries and data items compared to conventional simple keyword matching or static order, greatly improving search efficiency and operational suitability. Application fields include sales analysis, inventory management, accounting processing, automatic generation of management dashboards, and audit response material creation, making it effective for all data search operations requiring complex relevance evaluation.

The extracting unit is configured to estimate a user's emotion and adjust a method for extracting based on the estimated user's emotion. For example, if the user is relaxed, the extracting unit extracts detailed data. If the user is in a hurry, the extracting unit extracts concise data. If the user is excited, the extracting unit extracts visually stimulating data. Thus, by adjusting the method for extracting according to the user's emotion, user convenience is improved. Emotion estimation is realized, for example, by using an emotion engine or generative AI with emotion estimation functionality. Generative AI may include text generation AI (e.g., LLM) or multimodal generative AI, but is not limited to these examples. Specifically, the extracting unit collects the user's input interactions (e.g., keystroke speed, mouse movement patterns, voice tone, facial images, etc.) as multidimensional feature vectors (e.g., numerical arrays, 50-200 elements) in real time and inputs them into an emotion estimation AI module (e.g., large language model, multimodal emotion recognition model). Examples of AI input include text “I am in a hurry,” voice waveform data, and facial images (RGB array, 224×224 pixels). The extracting unit receives emotion labels (e.g., stress, relaxation, tension, excitement, etc.) and emotion scores (e.g., stress level 0.85, relaxation level 0.10, etc.) from the AI. Examples of output include emotion label “relaxation,” score 0.90, emotion label “excitement,” score 0.75, etc. Based on the emotion estimation result, the extracting unit dynamically switches extraction method parameters (e.g., number of extraction items, level of detail, data granularity, selection of extraction target tables, WHERE clause conditions in SQL queries, API parameters, etc.). For example, if the relaxation level is high, the extracting unit extracts detailed data including all items, detailed history, related data links, etc.; if the user is in a hurry, the extracting unit extracts only key figures or summaries; if the excitement level is high, the extracting unit generates visually stimulating data using colors and animations (e.g., graph images, highlighted data, etc.). AI modules (e.g., large language models or multimodal generative AI) input emotion labels and extraction templates and output the optimal extraction method (e.g., detail parameter, extraction item list, data formatting method, etc.). Examples of AI input include emotion label “in a hurry,” extraction template “Sales Data Details,” etc.; examples of output include “Extract summary only,” “Expand detailed items,” etc. In subsequent processing, the extracting unit passes the extraction result to the returning unit, which performs automatic mapping and format formatting to the Excel file. As a technical effect, this extracting unit realizes dynamic optimization of extraction methods by AI reflecting the user's emotional state in real time compared to conventional static data extraction, reducing stress due to information overload or lack of information and greatly improving the degree of personalization of the extraction experience. Furthermore, emotion-linked extraction control does not rely on human subjectivity or experience, but realizes high-precision decision-making and automation by computer, providing technical superiority in both operational efficiency and user experience. Application fields include sales analysis, inventory management, accounting processing, automatic generation of management dashboards, and audit response material creation, making it effective for all data extraction operations where emotion or stress affects operational efficiency.

The extracting unit improves extraction accuracy by considering the interrelationship of data during extraction. For example, the extracting unit analyzes the interrelationship of data and extracts highly relevant data. The extracting unit may also improve the accuracy of extraction results based on the interrelationship of data, and adjust the display order of extraction results by considering the interrelationship of data. Thus, by considering the interrelationship of data, extraction accuracy can be improved. Specifically, the extracting unit receives a record ID list and related meta-information (e.g., data category, related ID, timestamp, etc.) from the searching unit as input, and internally constructs a graph structure representing the interrelationship among data items in the database (e.g., nodes=data items, edges=relationships), such as foreign keys, referential integrity, time-series dependencies, and business process linkages. The extracting unit applies graph search algorithms (e.g., breadth-first search, depth-first search, PageRank, community detection, etc.) and relevance score calculations (e.g., Jaccard coefficient, cosine similarity, co-occurrence frequency, etc.) to automatically add data with high relevance to the extraction candidates. For example, if sales data and inventory data are linked by the same project ID, the extracting unit extracts both simultaneously and outputs them sorted by relevance score. When incorporating AI modules (e.g., graph neural networks or relevance estimation AI), the system inputs relationship matrices or feature vectors between data and outputs relevance scores and extraction priorities. Example AI inputs include data IDs such as “Sales123” and “Inventory456”, and relationships such as “ProjectA”; example outputs include “Sales 123-Inventory456” (score 0.92). The extracting unit dynamically adjusts the display order and selection of extraction results based on these scores. In subsequent processing, the returning unit maps this relevance-tagged data to Excel or similar and returns it to the user. As a technical effect, the extracting unit, by analyzing and reflecting complex interrelationships among data with high accuracy compared to conventional simple data extraction, greatly improves the consistency of overall business processes and the quality of decision-making. Applicable fields include business analysis, inventory management, project management, accounting, audit documentation, and any business where the relevance among multiple data is important.

The extracting unit performs extraction by considering attribute information of the data submitter during extraction. For example, the extracting unit prioritizes the extraction of important data based on the submitter's position, extracts highly relevant data based on the submitter's department, and adjusts extraction results by referring to the submitter's past submission history. Thus, by considering the attribute information of the data submitter, highly relevant data can be extracted. Specifically, the extracting unit refers to submitter attribute meta-information assigned to each data item in the database (e.g., position label, department code, submitter ID, submission date and time, number of past submissions, etc.), and automatically applies these attributes as filter conditions or weighting parameters when generating extraction queries. For example, if the position is “Manager” or “Executive”, the extracting unit prioritizes the extraction of their submitted data; if the department is “Sales”, sales-related data is extracted; and data from submitters with many past submissions is extracted with a high reliability score. When incorporating AI modules (e.g., attribute classification AI or submitter reliability estimation AI), the system inputs submitter attribute vectors (e.g., position, department, submission frequency, etc.) and a list of data items, and outputs extraction priority scores for each data. Example AI inputs include submitter “Manager”, “Sales Department”, “Submission count 50”; example outputs include “Sales Data” (score 0.95), “Inventory Data” (score 0.80). The extracting unit dynamically adjusts the display order and selection of extraction results based on these scores. In subsequent processing, the returning unit maps this attribute-considered data to Excel or similar and returns it to the user. As a technical effect, the extracting unit, by accurately reflecting attribute information such as position, department, and history compared to conventional uniform data extraction, greatly improves the reliability and efficiency of business decision-making and audit response. Applicable fields include management analysis, audit response, sales management, departmental aggregation, and any business where submitter attributes are important.

The extracting unit estimates a user's emotion and determines a priority order of data to be extracted based on the estimated user's emotion. For example, if the user is nervous, the extracting unit prioritizes the extraction of important data; if the user is relaxed, it prioritizes the extraction of detailed data; and if the user is in a hurry, it prioritizes the extraction of data that can be quickly extracted. Thus, by determining the priority order of data according to the user's emotion, user convenience is improved. Emotion estimation is realized using, for example, an emotion engine or generative AI, such as text generation AI (e.g., LLM) or multimodal generative AI, but is not limited to these examples. Specifically, the extracting unit collects the user's input interactions (e.g., keystroke speed, mouse movement patterns, voice tone, facial images, etc.) as multidimensional feature vectors (e.g., numerical arrays, 50-200 elements) and inputs them to an emotion estimation AI module (e.g., large language model, multimodal emotion recognition model). Example AI inputs include text “I am nervous”, audio waveform data, and facial images (RGB array, 224×224 pixels). The extracting unit receives emotion labels (e.g., nervous, relaxed, stressed, excited, etc.) and emotion scores (e.g., nervousness 0.80, relaxation 0.10, etc.) as output from the AI. Example outputs include emotion label “nervous”, score 0.80. Based on the emotion estimation results, the extracting unit automatically calculates priority scores for the data to be extracted (e.g., importance, extraction speed, detail level, etc.) and dynamically adjusts the order of the candidate list (one-dimensional array, each element with data ID and priority score). For example, if nervousness is high, important data such as “Sales” and “Inventory” are placed at the top; if relaxation is high, detailed data such as “Detailed Sales Breakdown” and “Inventory Location” are placed at the top; and if the user is in a hurry, quickly extractable data such as “Simple Sales” and “Instant Inventory” are placed at the top. AI modules (e.g., large language models or decision-making AI) input emotion labels and data lists and output priority scores for each data (e.g., 0.95, 0.80, 0.60, etc.). The extracting unit automatically adjusts the extraction order and UI display methods (e.g., highlighting, color coding, etc.) based on these scores. In subsequent processing, when the user selects or newly extracts data, the selection result and emotion estimation value are recorded in a history database and used to improve the accuracy of priority determination in future sessions. As a technical effect, the extracting unit, by realizing dynamic prioritization reflecting the user's emotional state in real time compared to conventional static data extraction, greatly improves extraction efficiency and user satisfaction, and reduces extraction errors and dropout rates. Furthermore, emotion-linked prioritization control enables high-precision decision-making and automation by computer without relying on human subjectivity or experience, providing technical superiority in both business efficiency and user experience. Applicable fields include business analysis, inventory management, accounting, management dashboard auto-generation, audit documentation, and any data extraction business where emotion or stress affects business efficiency.

The extracting unit performs extraction by considering the geographic distribution of data during extraction. For example, the extracting unit prioritizes the extraction of data related to a specific region, extracts highly relevant data based on geographic distribution, and adjusts the display order of extraction results by considering geographic distribution. Thus, by considering the geographic distribution of data, highly relevant data can be extracted. Specifically, the extracting unit refers to geographic attribute information assigned to each data item in the database (e.g., latitude and longitude, region code, warehouse ID, prefecture, city, etc.), and prioritizes the extraction of data that matches or is near the user's current location or specified region when generating extraction queries. For example, if the user is at “Warehouse A” (latitude 35.123456, longitude 139.654321), the extracting unit prioritizes the extraction of data such as “Warehouse A Inventory” and “Warehouse A In/Out History”. The extracting unit automatically adjusts the display order of extraction results based on geographic distribution (e.g., by distance, by regional importance, etc.). When incorporating AI modules (e.g., geographic information analysis AI or spatiotemporal pattern recognition AI), the system inputs location information vectors (e.g., latitude and longitude, movement speed, dwell time, etc.) and a list of data items, and outputs regional relevance scores for each data (e.g., 0.95, 0.80, 0.60, etc.). Example AI inputs include latitude 35.123456, longitude 139.654321, data items “Warehouse A Inventory”, “Warehouse B Inventory”, etc. ; example outputs include “Warehouse A Inventory” (score 0.95), “Warehouse B Inventory” (score 0.10). The extracting unit dynamically adjusts the display order and selection of extraction results based on these scores. In subsequent processing, the returning unit maps this geographic information-tagged data to Excel or similar and returns it to the user. As a technical effect, the extracting unit, by realizing dynamic region-linked extraction reflecting the user's current location and business site geographic elements in real time compared to conventional static data extraction, greatly improves extraction efficiency and business suitability for on-site and region-specific operations. Furthermore, geographic information-linked optimization enables automation and optimization by computer without relying on human memory or manual selection, making it effective for logistics management, field operations, sales activities, field services, and any business where geographic elements are important.

The extracting unit improves extraction accuracy by referring to related literature of the data during extraction. For example, the extracting unit refers to related literature to extract highly relevant data, improves the accuracy of extraction results based on related literature, and adjusts the display order of extraction results by considering related literature. Thus, by referring to related literature, extraction accuracy can be improved. Specifically, the extracting unit manages related literature information linked to each data item (e.g., paper ID, patent number, technical report ID, literature title, publication year, etc.) as meta-information, and automatically refers to the presence of related literature and relevance scores (e.g., TF-IDF, cosine similarity, citation count, etc.) when generating extraction queries. The extracting unit analyzes the content of related literature (e.g., summary text, keywords, citation relationships, etc.) using natural language processing modules (e.g., morphological analysis, keyword extraction, semantic similarity calculation, etc.) to quantify the relevance to the data to be extracted. When incorporating AI modules (e.g., large language models or literature relevance estimation AI), the system vectorizes data item descriptions and related literature texts and outputs semantic relevance scores. Example AI inputs include data description “June 2024 Sales”, literature title “2024 Sales Analysis Report”; example outputs include “June 2024 Sales-2024 Sales Analysis Report” (score 0.92). The extracting unit dynamically adjusts the display order and selection of extraction results based on these scores. In subsequent processing, the returning unit maps this literature-related data to Excel or similar and returns it to the user. As a technical effect, the extracting unit, by utilizing related literature information with high accuracy compared to conventional simple data extraction, greatly enhances the basis and accountability in business, and significantly improves the reliability and efficiency of audit response and report creation. Applicable fields include management analysis, audit response, research and development, technical report creation, and any business where literature reference is important.

The returning unit estimates a user's emotion and adjusts a method for returning based on the estimated user's emotion. For example, if the user is relaxed, the returning unit provides a detailed returning method; if the user is in a hurry, it provides a concise returning method; and if the user is excited, it provides a visually stimulating returning method. Thus, by adjusting the returning method according to the user's emotion, user convenience is improved. Emotion estimation is realized using, for example, an emotion engine or generative AI, such as text generation AI (e.g., LLM) or multimodal generative AI, but is not limited to these examples. Specifically, the returning unit collects the user's input interactions (keystroke speed, mouse movement patterns, voice tone, facial images, etc.) as multidimensional feature vectors (numerical arrays, 50-200 elements) in real time and inputs them to an emotion estimation AI module (large language model or multimodal emotion recognition model). Example AI inputs include text “I am in a hurry”, audio waveform data, and facial images (RGB array, 224×224 pixels). The returning unit receives emotion labels (stress, relaxation, tension, excitement, etc.) and emotion scores (stress level 0.85, relaxation level 0.10, etc.) as output from the AI. Example outputs include emotion label “relaxation”, score 0.90; emotion label “excitement”, score 0.75. Based on the emotion estimation results, the returning unit dynamically switches parameters for the returning method (number of returned items, level of detail, data granularity, selection of target cells, format template, UI layout, etc.). For example, if relaxation is high, the returning unit returns all items, detailed history, and related data links as detailed data to Excel; if the user is in a hurry, only key figures and summaries are returned. If excitement is high, the returning unit presents the results in a visually stimulating UI using colors and animations. AI modules (large language models or multimodal generative AI) input emotion labels and returning templates and output the optimal returning method (detail parameters, list of returned items, data formatting method, UI layout, etc.). Example AI inputs include emotion label “in a hurry”, returning template “Sales Data Details”; example outputs include “Return summary only”, “Expand detailed items”, etc. The returning unit automatically adjusts the content of returned data and UI display methods (highlighting, color coding, animation, etc.) based on these AI outputs. In subsequent processing, when the user checks the returned data, operation logs (click locations, viewing time, etc.) are recorded in a history database and used to optimize the returning method in future sessions. As a technical effect, the returning unit, by realizing dynamic optimization of the returning method reflecting the user's emotional state in real time with AI compared to conventional static returning methods, greatly improves the degree of personalization of the returning experience and reduces confusion due to information overload and dissatisfaction due to lack of information. Furthermore, emotion-linked returning control enables high-precision decision-making and automation by computer without relying on human subjectivity or experience, providing technical superiority in both business efficiency and user experience. Applicable fields include business analysis, inventory management, accounting, management dashboard auto-generation, audit documentation, and any data returning business where emotion or stress affects business efficiency.

The returning unit adjusts a level of detail for returning based on the importance of the data during returning. For example, the returning unit provides a detailed returning method for important data, and a concise returning method for general data, and adjusts the display order of the returning method according to the importance of the data. Thus, by adjusting the level of detail for returning based on the importance of the data, important data can be preferentially returned. Specifically, the returning unit assigns an importance score (0.0-1.0, managed as meta-information) to each item of the data to be returned and refers to this score during the returning process. For items with a high importance score (management indicators, audit-required items, etc.), the returning unit automatically generates a detailed returning method (full history, related data links, graph display, etc.), and for items with a low importance score (supplementary information, reference values, etc.), only summaries or key values are returned. The returning unit sorts the display order of returned data in descending order of importance score, allowing the user to quickly access the most important information. When incorporating AI modules (importance estimation AI or decision-making AI), the system inputs meta-information of data items (usage frequency, business impact, past reference history, etc.) and outputs importance scores for each item. Example AI inputs include item names such as “Sales Data”, “Inventory Data”, “Customer ID” and usage frequencies “100 times”, “50 times”, “10 times”; example outputs include “Sales Data” (score 0.95), “Inventory Data” (score 0.80), “Customer ID” (score 0.60). The returning unit dynamically adjusts the level of detail and display order of returned data based on these scores. In subsequent processing, the user's history of viewing and selecting returned data is recorded in a database and used to improve importance estimation and optimization of the returning method in future sessions. As a technical effect, the returning unit, by realizing flexible detail control reflecting the business importance of data compared to conventional uniform returning methods, prevents information oversight and misrecognition, and achieves both faster decision-making and improved business efficiency. Applicable fields include management analysis, audit response, sales strategy planning, inventory optimization, and any business where preferential returning of important data is required.

The returning unit applies different returning algorithms according to the category of the data during returning. For example, the returning unit applies a sales-specific returning algorithm for sales data, an inventory management-specific returning algorithm for inventory data, and a customer management-specific returning algorithm for customer data. Thus, by applying different returning algorithms according to the category of the data, the accuracy of returning is improved. Specifically, the returning unit is equipped with a category classification module that automatically determines the category (sales, inventory, customer, etc.) of each item name in the list of data items to be returned (one-dimensional array, each element is a UTF-8 encoded string) received from the receiving unit or extracting unit. For the sales category, a time-series returning algorithm (period specification, moving average, anomaly highlighting, etc.) is applied; for the inventory category, a location-based returning algorithm (warehouse ID aggregation, inventory fluctuation history, lot management, etc.) is applied; and for the customer category, an attribute-matching returning algorithm (by customer ID, attribute filter, similar customer grouping, etc.) is applied. The returning unit automatically selects optimized format conversion, cell mapping, graph generation, and UI layout for each category to achieve both returning accuracy and business suitability. When incorporating AI modules (category classification AI or returning algorithm selection AI), the system inputs item names and past returning history and outputs the optimal returning algorithm (time-series expansion, location-based aggregation, attribute-based grouping, etc.). Example AI inputs include item names such as “Sales Data”, “June 2024 Sales”, “Warehouse A Inventory”; example outputs include “Time-series returning”, “Location-based returning”, “Attribute-based returning”. The returning unit automates the formatting, cell placement, and graph generation of returned data based on these outputs. In subsequent processing, the user's history of checking and using returned data is recorded and used to optimize the returning algorithm in future sessions. As a technical effect, the returning unit, by realizing returning processing optimized for each data category compared to conventional uniform returning algorithm application, greatly improves returning accuracy, speed, and business suitability, and can flexibly respond to complex business requirements. Applicable fields include business analysis, inventory management, customer management, accounting, audit documentation, and any business where returning of multiple categories of data is required.

The returning unit estimates a user's emotion and adjusts a length of returning based on the estimated user's emotion. For example, if the user is in a hurry, the returning unit provides a short and concise returning method; if the user is relaxed, it provides a detailed returning method; and if the user is excited, it provides a visually stimulating returning method. Thus, by adjusting the length of returning according to the user's emotion, user convenience is improved. Emotion estimation is realized using, for example, an emotion engine or generative AI, such as text generation AI (e.g., LLM) or multimodal generative AI, but is not limited to these examples. Specifically, the returning unit collects the user's input interactions (keystroke speed, mouse movement patterns, voice tone, facial images, etc.) as multidimensional feature vectors (numerical arrays, 50-200 elements) and inputs them to an emotion estimation AI module (large language model or multimodal emotion recognition model). Example AI inputs include text “I am in a hurry”, audio waveform data, and facial images (RGB array, 224×224 pixels). The returning unit receives emotion labels (stress, relaxation, tension, excitement, etc.) and emotion scores (stress level 0.85, relaxation level 0.10, etc.) as output from the AI. Example outputs include emotion label “in a hurry”, score 0.90; emotion label “relaxation”, score 0.80. Based on the emotion estimation results, the returning unit dynamically adjusts the length of returned data (number of display items, presence of summary, presence of detailed expansion, etc.). For example, if the user is in a hurry, the returning unit returns only key figures and summaries; if the user is relaxed, it expands all items, detailed graphs, and related data links. If excitement is high, the returning unit presents the results in a visually stimulating UI using animations and colors. AI modules (large language models or multimodal generative AI) input emotion labels and returning templates and output the optimal length and expression method (number of items, level of detail, UI layout, etc.). Example AI inputs include emotion label “in a hurry”, returning template “Sales Data Details”; example outputs include “Return summary only”, “Expand detailed items”, etc. In subsequent processing, the returning unit records operation logs (viewing time, number of detail expansions, etc.) when the user checks the returned data in a history database and uses them to optimize the length in future sessions. As a technical effect, the returning unit, by realizing dynamic length control reflecting the user's emotional state in real time with AI compared to conventional static returning methods, reduces stress due to information overload or lack of information and greatly improves the degree of personalization of the returning experience. Applicable fields include business analysis, inventory management, accounting, management dashboard auto-generation, audit documentation, and any data returning business where emotion or stress affects business efficiency.

The returning unit determines a priority order for returning based on the submission timing of the data during returning. For example, the returning unit preferentially returns the latest data, refers to past data to preferentially return highly relevant data, and adjusts the display order of the returning method according to the submission timing of the data. Thus, by determining the priority order for returning based on the submission timing of the data, the latest data can be preferentially returned. Specifically, the returning unit assigns submission timing (timestamp, YYYY/MM/DD HH:MM:SS format) as meta-information to each item of the data to be returned and refers to this submission timing during the returning process. The returning unit sorts the returned data in order of newest submission timing or by periods of high relevance according to the user's request or business scenario (e.g., latest sales, inventory trends over the past three months, etc.). When incorporating AI modules (time-series analysis AI or submission timing weighting AI), the system inputs the submission timing of data items and business requirements (latest data priority, reference to past data, etc.) and outputs priority scores for each data (e.g., 0.95, 0.80, 0.60, etc.). Example AI inputs include “Sales Data”, “Submission timing: 2024 Jun. 1”, “Submission timing: 2024 May 1”; example outputs include “2024 Jun. 1” (score 0.95), “2024 May 1” (score 0.80). The returning unit dynamically adjusts the display order and filtering conditions of returned data based on these scores. In subsequent processing, the user's history of selecting and viewing returned data is recorded in a database and used to improve the accuracy of priority determination in future sessions. As a technical effect, the returning unit, by realizing dynamic priority control reflecting the submission timing of data in real time compared to conventional static returning methods, enables rapid understanding of the latest information and appropriate reference to past data, greatly improving business efficiency and decision-making accuracy. Applicable fields include business analysis, inventory management, accounting, management dashboard auto-generation, audit documentation, and any business where priority returning of time-series data is required.

The returning unit adjusts a returning order based on the relevance of the data during returning. For example, the returning unit preferentially returns highly relevant data, postpones less relevant data, and adjusts the display order of the returning method according to the relevance of the data. Thus, by adjusting the returning order based on the relevance of the data, highly relevant data can be preferentially returned. Specifically, the returning unit calculates relevance scores (0.0-1.0, TF-IDF, cosine similarity, semantic similarity, etc.) between the data to be returned and the user's request or business scenario, and automatically sorts the display order of returned data in descending order of relevance score. When incorporating AI modules (large language models or relevance estimation AI), the system vectorizes the returning request (e.g., “June 2024 Sales”) and the list of data items (e.g., “June 2024 Sales”, “2024/06 Sales”, “June 2024 Sales Results”, etc.), and outputs semantic relevance scores for each item. Example AI inputs include returning request “New Product Sales”, data items “New Product Sales”, “New Product Inventory”, “Existing Product Sales”; example outputs include “New Product Sales” (score 0.95), “New Product Inventory” (score 0.80), “Existing Product Sales” (score 0.60). The returning unit displays highly relevant data at the top and less relevant data at the bottom based on these scores. In subsequent processing, the user's history of selecting and viewing returned data is recorded and used to improve the accuracy of relevance estimation in future sessions. As a technical effect, the returning unit, by evaluating the semantic relevance between the returning request and data items with high accuracy compared to conventional simple keyword matching or static ordering, greatly improves returning efficiency and business suitability by presenting information that matches the user's intent. Applicable fields include business analysis, inventory management, accounting, management dashboard auto-generation, audit documentation, and any data returning business where complex relevance evaluation is required.

The proposing unit estimates a user's emotion and adjusts a method of proposal expression based on the estimated user's emotion. For example, if the user is relaxed, the proposing unit provides detailed proposals; if the user is in a hurry, it provides concise proposals; and if the user is excited, it provides visually stimulating proposals. Thus, by adjusting the method of proposal expression according to the user's emotion, user convenience is improved. Emotion estimation is realized using, for example, an emotion engine or generative AI, such as text generation AI (e.g., LLM) or multimodal generative AI, but is not limited to these examples. Specifically, the proposing unit collects the user's input interactions (keystroke speed, mouse movement patterns, voice tone, facial images, etc.) as multidimensional feature vectors (numerical arrays, 50-200 elements) in real time and inputs them to an emotion estimation AI module (large language model or multimodal emotion recognition model). Example AI inputs include text “I want a detailed explanation”, audio waveform data, and facial images (RGB array, 224×224 pixels). The proposing unit receives emotion labels (relaxation, stress, tension, excitement, etc.) and emotion scores (relaxation level 0.90, excitement level 0.75, etc.) as output from the AI. Example outputs include emotion label “relaxation”, score 0.90; emotion label “excitement”, score 0.75. Based on the emotion estimation results, the proposing unit dynamically switches the level of detail of proposal content (e.g., number of proposal items, length of explanation, presence of charts, UI layout, etc.) and expression methods (e.g., color, animation, highlighting, etc.). For example, if relaxation is high, the proposing unit presents detailed proposals (all items, background explanation, related data links, etc.); if the user is in a hurry, it presents concise proposals (main items, summary, graph thumbnails, etc.); and if excitement is high, it presents proposals in a visually stimulating UI using colors and animations. AI modules (large language models or multimodal generative AI) input emotion labels and proposal templates and output the optimal expression method (detail parameters, UI layout, highlighting elements, etc.). Example AI inputs include emotion label “relaxation”, proposal template “Sales Analysis Proposal”; example outputs include “With detailed explanation”, “Graph highlighting”, “Summary only”, etc. In subsequent processing, the proposing unit records operation logs (click locations, viewing time, etc.) when the user checks the proposal content in a history database and uses them to optimize the expression method in future sessions. As a technical effect, the proposing unit, by realizing dynamic UI optimization reflecting the user's emotional state in real time with AI compared to conventional static proposal display, greatly improves the degree of personalization of the proposal experience and reduces confusion due to information overload and dissatisfaction due to lack of information. Furthermore, emotion-linked expression control enables high-precision decision-making and automation by computer without relying on human subjectivity or experience, providing technical superiority in both business efficiency and user experience. Applicable fields include business analysis, inventory management, accounting, management dashboard auto-generation, audit documentation, and any proposal business where emotion or stress affects business efficiency.

The proposing unit adjusts a level of proposal detail based on the importance of the item name during proposal. For example, the proposing unit provides detailed proposals for important item names, concise proposals for general item names, and adjusts the display order of proposals according to the importance of the item name. Thus, by adjusting the level of proposal detail based on the importance of the item name, important item names can be preferentially proposed. Specifically, the proposing unit assigns an importance score (0.0-1.0, managed as meta-information) to each item name to be proposed and refers to this score during proposal generation. For item names with a high importance score (management indicators, audit-required items, etc.), the proposing unit automatically generates detailed proposals (full history, related data links, graph display, etc.), and for item names with a low importance score (supplementary information, reference values, etc.), only summaries or key values are proposed. The proposing unit sorts the display order of proposal content in descending order of importance score, allowing the user to quickly access the most important information. When incorporating AI modules (importance estimation AI or decision-making AI), the system inputs meta-information of item names (usage frequency, business impact, past reference history, etc.) and outputs importance scores for each item name. Example AI inputs include item names such as “Sales Data”, “Inventory Data”, “Customer ID” and usage frequencies “100 times”, “50 times”, “10 times”; example outputs include “Sales Data” (score 0.95), “Inventory Data” (score 0.80), “Customer ID” (score 0.60). The proposing unit dynamically adjusts the level of detail and display order of proposal content based on these scores. In subsequent processing, the user's history of viewing and selecting proposal content is recorded in a database and used to improve importance estimation and optimization of the proposal method in future sessions. As a technical effect, the proposing unit, by realizing flexible detail control reflecting the business importance of item names compared to conventional uniform proposal methods, prevents information oversight and misrecognition, and achieves both faster decision-making and improved business efficiency. Applicable fields include management analysis, audit response, sales strategy planning, inventory optimization, and any business where preferential proposal of important item names is required.

The proposing unit estimates a user's emotion and determines a priority order of proposals based on the estimated user's emotion. For example, if the user is nervous, the proposing unit prioritizes important proposals; if the user is relaxed, it prioritizes detailed proposals; and if the user is in a hurry, it prioritizes item names that can be proposed quickly. Thus, by determining the priority order of proposals according to the user's emotion, user convenience is improved. Emotion estimation is realized using, for example, an emotion engine or generative AI, such as text generation AI (e.g., LLM) or multimodal generative AI, but is not limited to these examples. Specifically, the proposing unit collects the user's input interactions (keystroke speed, mouse movement patterns, voice tone, facial images, etc.) as multidimensional feature vectors (numerical arrays, 50-200 elements) and inputs them to an emotion estimation AI module (large language model or multimodal emotion recognition model). Example AI inputs include text “I am nervous”, audio waveform data, and facial images (RGB array, 224×224 pixels). The proposing unit receives emotion labels (nervous, relaxed, stressed, excited, etc.) and emotion scores (nervousness 0.80, relaxation 0.10, etc.) as output from the AI. Example outputs include emotion label “nervous”, score 0.80. Based on the emotion estimation results, the proposing unit automatically calculates priority scores for the item names to be proposed (importance, proposal speed, detail level, etc.) and dynamically adjusts the order of the candidate list (one-dimensional array, each element with item name and priority score). For example, if nervousness is high, important items such as “Sales” and “Inventory” are placed at the top; if relaxation is high, detailed items such as “Detailed Sales Breakdown” and “Inventory Location” are placed at the top; and if the user is in a hurry, quickly proposable items such as “Simple Sales” and “Instant Inventory” are placed at the top. AI modules (large language models or decision-making AI) input emotion labels and item name lists and output priority scores for each item name (e.g., 0.95, 0.80, 0.60, etc.). The proposing unit automatically adjusts the proposal order and UI display methods (highlighting, color coding, etc.) based on these scores. In subsequent processing, when the user selects or newly inputs item names, the selection result and emotion estimation value are recorded in a history database and used to improve the accuracy of priority determination in future sessions. As a technical effect, the proposing unit, by realizing dynamic prioritization reflecting the user's emotional state in real time compared to conventional static proposals, greatly improves proposal efficiency and user satisfaction, and reduces proposal errors and dropout rates. Furthermore, emotion-linked prioritization control enables high-precision decision-making and automation by computer without relying on human subjectivity or experience, providing technical superiority in both business efficiency and user experience. Applicable fields include business analysis, inventory management, accounting, management dashboard auto-generation, audit documentation, and any proposal business where emotion or stress affects business efficiency.

The proposing unit adjusts a proposal order based on the relevance of the item name during proposal. For example, the proposing unit preferentially proposes highly relevant item names, postpones less relevant item names, and adjusts the display order of proposals according to the relevance of the item name. Thus, by adjusting the proposal order based on the relevance of the item name, highly relevant item names can be preferentially proposed. Specifically, the proposing unit calculates relevance scores (0.0-1.0, TF-IDF, cosine similarity, semantic similarity, etc.) between the proposal query and the list of item names, and automatically sorts the display order of proposal content in descending order of relevance score. When incorporating AI modules (large language models or relevance estimation AI), the system vectorizes the proposal query (e.g., “June 2024 Sales”) and the list of item names (e.g., “June 2024 Sales”, “2024/06 Sales”, “June 2024 Sales Results”, etc.), and outputs semantic relevance scores for each item. Example AI inputs include query “New Product Sales”, item names “New Product Sales”, “New Product Inventory”, “Existing Product Sales”; example outputs include “New Product Sales” (score 0.95), “New Product Inventory” (score 0.80), “Existing Product Sales” (score 0.60). The proposing unit displays highly relevant item names at the top and less relevant item names at the bottom based on these scores. In subsequent processing, the user's history of selecting and viewing item names is recorded and used to improve the accuracy of relevance estimation in future sessions. As a technical effect, the proposing unit, by evaluating the semantic relevance between the proposal query and item names with high accuracy compared to conventional simple keyword matching or static ordering, greatly improves proposal efficiency and business suitability by presenting information that matches the user's intent. Applicable fields include business analysis, inventory management, accounting, management dashboard auto-generation, audit documentation, and any proposal business where complex relevance evaluation is required.

The search algorithm estimates a user's emotion and selects a search algorithm based on the estimated user's emotion. For example, if the user is relaxed, the search algorithm applies a detailed search algorithm; if the user is in a hurry, it applies a concise search algorithm; and if the user is excited, it applies a visually stimulating search algorithm. Thus, by selecting a search algorithm according to the user's emotion, user convenience is improved. Emotion estimation is realized using, for example, an emotion engine or generative AI, such as text generation AI (e.g., LLM) or multimodal generative AI, but is not limited to these examples. Specifically, the search algorithm selection system collects the user's input interactions (keystroke speed, mouse movement patterns, voice tone, facial images, etc.) in real time and inputs them as multidimensional feature vectors (e.g., numerical arrays, 100 elements) to an emotion estimation AI module. Example AI inputs include text “I want a detailed search”, audio waveform data, and facial images (RGB array, 224×224 pixels). The system receives emotion labels (relaxation, stress, tension, excitement, etc.) and emotion scores (relaxation level 0.90, excitement level 0.75, etc.) as output from the AI. Example outputs include emotion label “relaxation”, score 0.90; emotion label “excitement”, score 0.75. Based on the emotion estimation results, the system automatically switches the type of search algorithm (e.g., detailed search algorithm, summary search algorithm, visually emphasized search algorithm, etc.). For example, if relaxation is high, the system applies a composite search algorithm including full-text search, related data link expansion, and detailed graph generation; if the user is in a hurry, it applies a fast search algorithm that extracts only key figures and summaries; and if excitement is high, it applies a visually stimulating UI with colors and animations. AI modules (large language models or multimodal generative AI) input emotion labels and search algorithm templates and output the optimal algorithm type (e.g., full-text search, summary search, graph-emphasized search, etc.). Example AI inputs include emotion label “in a hurry”, search algorithm template “Sales Data Details”; example outputs include “Summary search”, “Graph-emphasized search”, etc. The system dynamically adjusts the selection and parameters of the search algorithm (e.g., search depth, number of display items, UI layout, etc.) based on these AI outputs. In subsequent processing, when the user checks the search results, operation logs (click locations, viewing time, etc.) are recorded in a history database and used to improve the accuracy of algorithm selection in future sessions. As a technical effect, the search algorithm selection system, by realizing dynamic algorithm optimization reflecting the user's emotional state in real time with AI compared to conventional static algorithm application, greatly improves the degree of personalization of the search experience and reduces confusion due to information overload and dissatisfaction due to lack of information. Furthermore, emotion-linked algorithm control enables high-precision decision-making and automation by computer without relying on human subjectivity or experience, providing technical superiority in both business efficiency and user experience. Applicable fields include business analysis, inventory management, accounting, management dashboard auto-generation, audit documentation, and any data search business where emotion or stress affects business efficiency.

The search algorithm optimizes the search algorithm by referring to past search data during searching. For example, the search algorithm analyzes past search data to apply the optimal search algorithm, adjusts the search algorithm based on past search history, and improves the accuracy of search results by referring to past search data. Thus, by referring to past search data, the search algorithm is optimized and search accuracy is improved. Specifically, the search algorithm optimization system maintains a search history database for each user (e.g., time-series search query list, search result selection history, search algorithm application history, etc.) in internal storage, and during searching, quickly searches and aggregates past search history (e.g., search queries from the last 30 days, search times, applied search algorithms, evaluation scores of obtained search results, etc.) using user ID or business scenario as a key. The system generates an optimal search algorithm ranking (e.g., full-text search, summary search, regular expression search, etc.) based on history data and presents a candidate list (one-dimensional array, N elements, each element with algorithm name and application frequency score) to the search engine. Furthermore, the system aggregates evaluations of past search queries and obtained results (e.g., user click rate, viewing time, satisfaction feedback, etc.) and preferentially applies the algorithm with the highest evaluation. When incorporating AI modules (e.g., search history analysis AI or algorithm selection AI), the system vectorizes history data (e.g., past search query sequences, algorithm application history, evaluation scores, etc.) and outputs the optimal search algorithm to be applied next as a probability distribution (e.g., softmax output, probability value for each algorithm). Example AI inputs include past search queries such as “Sales Data Search”, “June 2024 Sales”, “Warehouse A Inventory”, applied algorithms “Full-text search”, “Summary search”, evaluation scores “0.85”, “0.90”; example AI outputs include candidate lists such as “Full-text search” (probability 0.65), “Summary search” (probability 0.30). The system dynamically adjusts the selection and parameters of the search algorithm (e.g., search depth, number of display items, etc.) based on these AI outputs. In subsequent processing, when the user selects or performs a new search, the result is immediately reflected in the history database and used to improve optimization accuracy in future sessions. As a technical effect, the search algorithm optimization system, by analyzing and reflecting user-specific history patterns and usage trends in real time compared to conventional static algorithm application, greatly improves search accuracy and business suitability, and prevents information oversight and misrecognition. Furthermore, history-based optimization enables high-precision pattern recognition and automation by computer without relying on human memory or experience, providing technical superiority in both business efficiency and user experience. Applicable fields include business analysis, inventory management, accounting, management dashboard auto-generation, audit documentation, and any repetitive data search business.

The search algorithm adjusts a frequency of the search algorithm based on the estimated user's emotion. For example, if the user is in a hurry, the search algorithm is applied frequently; if the user is relaxed, a detailed search algorithm is applied; and if the user is excited, a visually stimulating search algorithm is applied. Thus, by adjusting the frequency of the search algorithm according to the user's emotion, user convenience is improved. Emotion estimation is realized using, for example, an emotion engine or generative AI, such as text generation AI (e.g., LLM) or multimodal generative AI, but is not limited to these examples. Specifically, the search algorithm frequency control system collects the user's input interactions (keystroke speed, mouse movement patterns, voice tone, facial images, etc.) as multidimensional feature vectors (numerical arrays, 100 elements) in real time and inputs them to an emotion estimation AI module (large language model or multimodal emotion recognition model). Example AI inputs include text “I am in a hurry”, audio waveform data, and facial images (RGB array, 224×224 pixels). The system receives emotion labels (in a hurry, relaxation, excitement, etc.) and emotion scores (in a hurry level 0.90, relaxation level 0.80, etc.) as output from the AI. Example outputs include emotion label “in a hurry”, score 0.90; emotion label “relaxation”, score 0.80. Based on the emotion estimation results, the system dynamically adjusts the frequency of applying the search algorithm (e.g., number of automatic searches per minute, number of search triggers per user operation, etc.) and algorithm type (detailed search, summary search, visually emphasized search, etc.). For example, if the user is in a hurry, the system applies a frequent search algorithm that automatically executes searches for each user operation and updates search results sequentially; if the user is relaxed, a detailed search algorithm is applied only when the user explicitly presses the search button; and if excitement is high, a visually stimulating UI with colors and animations is applied. AI modules input emotion labels and search frequency templates and output optimal frequency parameters (e.g., automatic search interval, user operation trigger conditions, etc.). Example AI inputs include emotion label “in a hurry”, search frequency template “Sales Data Details”; example outputs include “Automatic search every minute”, “Search only on user operation”, etc. The system dynamically adjusts the frequency and parameters of the search algorithm based on these AI outputs. In subsequent processing, when the user checks the search results, operation logs (number of search executions, viewing time, etc.) are recorded in a history database and used to improve the accuracy of frequency control in future sessions. As a technical effect, the search algorithm frequency control system, by realizing dynamic frequency optimization reflecting the user's emotional state in real time with AI compared to conventional static frequency control, greatly improves the degree of personalization of the search experience and optimizes the timing and amount of information acquisition. Furthermore, emotion-linked frequency control enables high-precision decision-making and automation by computer without relying on human subjectivity or experience, providing technical superiority in both business efficiency and user experience. Applicable fields include business analysis, inventory management, accounting, management dashboard auto-generation, audit documentation, and any data search business where emotion or stress affects business efficiency.

The search algorithm weights the search algorithm based on the submission timing of the data during searching. For example, the search algorithm applies weighting to the latest data, applies weighting to past data, and adjusts the weighting of the search algorithm according to the submission timing of the data. Thus, by weighting the search algorithm based on the submission timing of the data, the latest data can be preferentially searched. Specifically, the search algorithm weighting system assigns submission timing (timestamp, YYYY/MM/DD HH:MM:SS format) as meta-information to each data item in the database and refers to this submission timing when executing search queries. The system automatically sets the weighting parameters of the search algorithm (e.g., weight values 0.95, 0.80, 0.60, etc.) in order of newest submission timing or by periods of high relevance according to the user's request or business scenario (e.g., latest sales, inventory trends over the past three months, etc.). When incorporating AI modules (time-series analysis AI or submission timing weighting AI), the system inputs the submission timing of data items and business requirements (latest data priority, reference to past data, etc.) and outputs priority scores for each data. Example AI inputs include “Sales Data”, “Submission timing: 2024 Jun. 1”, “Submission timing: 2024 May 1”; example outputs include “2024 Jun. 1” (score 0.95), “2024 May 1” (score 0.80). The system dynamically adjusts the weighting, display order, and filtering conditions of the search algorithm based on these scores. For example, if the score for the latest data is high, the system preferentially searches and displays the latest data; if the score for past data is high, the system applies an algorithm that focuses on searching past data. In subsequent processing, the user's history of selecting and viewing search results is recorded in a database and used to improve the accuracy of weighting in future sessions. As a technical effect, the search algorithm weighting system, by realizing dynamic weighting control reflecting the submission timing of data in real time compared to conventional static search algorithm application, enables rapid understanding of the latest information and appropriate reference to past data, greatly improving business efficiency and decision-making accuracy. Applicable fields include business analysis, inventory management, accounting, management dashboard auto-generation, audit documentation, and any business where priority searching of time-series data is required.

The method for extracting estimates a user's emotion and adjusts the method for extracting based on the estimated user's emotion. For example, if the user is relaxed, the method for extracting applies a detailed extraction method; if the user is in a hurry, it applies a concise extraction method; and if the user is excited, it applies a visually stimulating extraction method. Thus, by adjusting the method for extracting according to the user's emotion, user convenience is improved. Emotion estimation is realized using, for example, an emotion engine or generative AI, such as text generation AI (e.g., LLM) or multimodal generative AI, but is not limited to these examples. Specifically, the extraction method control system collects the user's input interactions (keystroke speed, mouse movement patterns, voice tone, facial images, etc.) as multidimensional feature vectors (numerical arrays, 100 elements) in real time and inputs them to an emotion estimation AI module (large language model or multimodal emotion recognition model). Example AI inputs include text “I am relaxed”, audio waveform data, and facial images (RGB array, 224×224 pixels). The system receives emotion labels (relaxation, in a hurry, excitement, etc.) and emotion scores (relaxation level 0.90, in a hurry level 0.80, etc.) as output from the AI. Example outputs include emotion label “relaxation”, score 0.90; emotion label “in a hurry”, score 0.80. Based on the emotion estimation results, the extraction method control system dynamically switches parameters for the extraction method (number of extraction items, level of detail, data granularity, selection of target tables, SQL WHERE clause conditions, API parameters, etc.). For example, if relaxation is high, the system extracts all items, detailed history, and related data links as detailed data; if the user is in a hurry, only key figures and summaries are extracted. If excitement is high, the system generates visually stimulating data (graph images, highlighted data, etc.) using colors and animations. AI modules input emotion labels and extraction templates and output the optimal extraction method (detail parameters, list of extraction items, data formatting method, etc.). Example AI inputs include emotion label “in a hurry”, extraction template “Sales Data Details”; example outputs include “Extract summary only”, “Expand detailed items”, etc. The system automatically adjusts the content of the extraction method and UI display methods (highlighting, color coding, animation, etc.) based on these AI outputs. In subsequent processing, the extraction results are passed to the returning unit, which performs automatic mapping to Excel files and format shaping. As a technical effect, the extraction method control system, by realizing dynamic optimization of the extraction method reflecting the user's emotional state in real time with AI compared to conventional static data extraction, reduces stress due to information overload or lack of information and greatly improves the degree of personalization of the extraction experience. Furthermore, emotion-linked extraction control enables high-precision decision-making and automation by computer without relying on human subjectivity or experience, providing technical superiority in both business efficiency and user experience. Applicable fields include business analysis, inventory management, accounting, management dashboard auto-generation, audit documentation, and any data extraction business where emotion or stress affects business efficiency.

The method for extracting is optimized at the time of extraction by referring to past extraction data. The method for extracting, for example, analyzes past extraction data and applies the optimal extraction method. The method for extracting may also be adjusted based on past extraction history. Furthermore, the method for extracting may improve the accuracy of extraction results by referencing past extraction data. By referring to past extraction data, the method for extracting can be optimized and the accuracy of extraction can be improved. Specifically, the extraction method optimization system according to the present embodiment stores, for each user, an extraction history database (e.g., time-series extraction query list, extraction result selection history, extraction method application history, evaluation scores of extraction results, etc.) in internal storage, and at the time of extraction, rapidly searches and aggregates past extraction history (e.g., extraction queries from the last 30 days, extraction times, applied extraction methods, evaluation scores of obtained extraction results, etc.) using user ID or business scenario as a key. The system generates an optimal extraction method ranking (e.g., full item extraction, summary extraction, regular expression extraction, attribute filter extraction, etc.) based on the history data and presents a candidate list (one-dimensional array, each element includes extraction method name and application frequency score) to the extraction engine. Furthermore, the system aggregates evaluations of past extraction queries and obtained results (e.g., user click-through rate, viewing time, satisfaction feedback, etc.) and preferentially applies the extraction method that received the highest evaluation. When incorporating AI modules (e.g., extraction history analysis AI or extraction method selection AI), the history data (e.g., past extraction query sequences, extraction method application history, evaluation scores, etc.) are vectorized, and the optimal extraction method to be applied next is output as a probability distribution (e.g., softmax output, probability value for each extraction method). Examples of AI input include past extraction queries such as “sales data extraction,” “June 2024 sales,” “A warehouse inventory count,” applied extraction methods such as “full item extraction,” “summary extraction,” and evaluation scores such as “0.85,” “0.90.” Examples of AI output include candidate lists such as “full item extraction” (probability 0.65), “summary extraction” (probability 0.30), etc. The system dynamically adjusts extraction method selection and parameters (e.g., extraction depth, number of display items, etc.) based on these AI outputs. As a subsequent process, when the user selects or newly extracts an extraction result, the result is immediately reflected in the history database and utilized to improve optimization accuracy in future extractions. As a technical effect, the extraction method optimization system according to the present embodiment, compared to conventional static extraction method application, can greatly improve extraction accuracy and business suitability by analyzing and reflecting user-specific history patterns and usage trends in real time, thereby preventing information oversight and misrecognition. Furthermore, history-based optimization does not depend on human memory or experience, and achieves high-precision pattern recognition and automation by computer, providing technical superiority in both business efficiency and user experience. Applicable fields include sales analysis, inventory management, accounting processing, automatic generation of management dashboards, preparation of audit response materials, and all repetitive data extraction operations.

The method for extracting estimates a user's emotion and adjusts the frequency of the extraction method based on the estimated user's emotion. For example, if the user is in a hurry, the extraction method is applied frequently. If the user is relaxed, a detailed extraction method is applied. If the user is excited, a visually stimulating extraction method is applied. By adjusting the frequency of the extraction method according to the user's emotion, user convenience is improved. Emotion estimation is realized, for example, by using an emotion engine or generative AI with emotion estimation functionality. Generative AI may include text generation AI (e.g., LLM) or multimodal generative AI, but is not limited to these examples. Specifically, the extraction method frequency control system according to the present embodiment collects user input interactions (keystroke speed, mouse movement patterns, voice tone, facial images, etc.) as multidimensional feature vectors (numerical arrays, 100 elements) in real time and inputs them into an emotion estimation AI module (large language model or multimodal emotion recognition model). The system prepares AI input examples such as text “I am in a hurry,” audio waveform data, and facial images (RGB array, 224×224 pixels). The system receives emotion labels (in a hurry, relaxed, excited, etc.) and emotion scores (hurry level 0.90, relaxation level 0.80, etc.) as output from the AI. Output examples include emotion label “in a hurry,” score 0.90, emotion label “relaxed,” score 0.80, etc. The extraction method frequency control system dynamically adjusts the application frequency of the extraction method (e.g., number of automatic extractions per minute, number of extraction triggers per user operation, etc.) and extraction method type (detailed extraction, summary extraction, visually emphasized extraction, etc.) based on the emotion estimation results. For example, if the user is in a hurry, the system automatically executes extraction immediately for each user operation and applies a frequent extraction method that sequentially updates the extraction results. If the user is relaxed, a detailed extraction method is applied only when the user explicitly presses the extraction button. If the excitement level is high, an extraction method with a visually stimulating UI using colors and animations is applied. The AI module takes emotion labels and extraction frequency templates as input and outputs optimal frequency parameters (e.g., automatic extraction interval, user operation trigger conditions, etc.). Examples of AI input include emotion label “in a hurry,” extraction frequency template “sales data details,” and output examples include “automatic extraction every minute,” “extraction only when user operates,” etc. The system dynamically adjusts the frequency and parameters of the extraction method based on these AI outputs. As a subsequent process, operation logs (number of extractions executed, viewing time, etc.) when the user checks the extraction results are recorded in the history database and used to improve the accuracy of frequency control in future extractions. As a technical effect, the extraction method frequency control system according to the present embodiment, compared to conventional static extraction frequency control, realizes dynamic frequency optimization reflecting the user's emotional state in real time using AI, greatly improving the degree of personalization of the extraction experience and optimizing the timing and amount of information acquisition. Furthermore, emotion-linked frequency control does not depend on human subjectivity or experience, and achieves high-precision decision-making and automation by computer, providing technical superiority in both business efficiency and user experience. Applicable fields include sales analysis, inventory management, accounting processing, automatic generation of management dashboards, preparation of audit response materials, and all data extraction operations where emotion or stress affects business efficiency.

The method for extracting weights the extraction method at the time of extraction based on the submission timing of the data. For example, the method for extracting applies weighting to the latest data. The method for extracting may also apply weighting to past data. The method for extracting adjusts the weighting according to the submission timing of the data. By weighting the extraction method based on the submission timing of the data, the latest data can be preferentially extracted. Specifically, the extraction method weighting system according to the present embodiment assigns submission timing (timestamp, YYYY/MM/DD HH:MM:SS format) as meta-information to each data item in the database and refers to this submission timing when executing extraction queries. The system automatically sets weighting parameters (weight values 0.95, 0.80, 0.60, etc.) for the extraction method in order of newest submission timing or most relevant timing according to user requests and business scenarios (latest sales, inventory trends over the past three months, etc.). When incorporating AI modules (time-series analysis AI or submission timing weighting AI), the submission timing of data items and business requirements (priority on latest data, reference to past data, etc.) are input, and priority scores for each data are output. Examples of AI input include “sales data,” “submission timing: 2024 Jun 1,” “submission timing: 2024 May 1,” and output examples include “2024 Jun. 1” (score 0.95), “2024 May 1” (score 0.80), etc. The system dynamically adjusts the weighting, display order, and filtering conditions of the extraction method based on these scores. For example, if the score for the latest data is high, the system preferentially extracts and displays the latest data, and if the score for past data is high, an algorithm that focuses on extracting past data is applied. As a subsequent process, the user's history of selecting and viewing extraction results is recorded in the database and used to improve the accuracy of weighting in future extractions. As a technical effect, the extraction method weighting system according to the present embodiment, compared to conventional static extraction method application, realizes dynamic weighting control reflecting the submission timing of data in real time, enabling rapid acquisition of the latest information and appropriate reference to past data, thereby greatly improving business efficiency and decision-making accuracy. Applicable fields include sales analysis, inventory management, accounting processing, automatic generation of management dashboards, preparation of audit response materials, and all operations requiring prioritized extraction of time-series data.

The format estimates a user's emotion and adjusts the method of format expression based on the estimated user's emotion. For example, if the user is relaxed, a detailed format is provided. If the user is in a hurry, a concise format is provided. If the user is excited, a visually stimulating format is provided. By adjusting the method of format expression according to the user's emotion, user convenience is improved. Emotion estimation is realized, for example, by using an emotion engine or generative AI with emotion estimation functionality. Generative AI may include text generation AI (e.g., LLM) or multimodal generative AI, but is not limited to these examples. Specifically, the format control system according to the present embodiment collects user input interactions (keystroke speed, mouse movement patterns, voice tone, facial images, etc.) as multidimensional feature vectors (numerical arrays, 100 elements) in real time and inputs them into an emotion estimation AI module (large language model or multimodal emotion recognition model). The system prepares AI input examples such as text “I am relaxed,” audio waveform data, and facial images (RGB array, 224×224 pixels). The system receives emotion labels (relaxed, in a hurry, excited, etc.) and emotion scores (relaxation level 0.90, hurry level 0.80, etc.) as output from the AI. Output examples include emotion label “relaxed,” score 0.90, emotion label “in a hurry,” score 0.80, etc. The format control system dynamically switches format parameters (level of detail, number of items, color, UI layout, presence of animation, etc.) based on the emotion estimation results. For example, if the relaxation level is high, the system generates a detailed format including all items, detailed history, related data links, etc.; if the user is in a hurry, the system generates a concise format including only key figures and summaries; if the excitement level is high, the system generates a visually stimulating format using colors and animations. The AI module takes emotion labels and format templates as input and outputs optimal format parameters (level of detail, color, UI layout, etc.). Examples of AI input include emotion label “in a hurry,” format template “sales data details,” and output examples include “summary only,” “expand detailed items,” “emphasize graph,” etc. The system automatically adjusts format content and UI display methods (emphasized display, color coding, animation, etc.) based on these AI outputs. As a subsequent process, operation logs (viewing time, number of times details are expanded, etc.) when the user checks the format results are recorded in the history database and used for format optimization in future operations. As a technical effect, the format control system according to the present embodiment, compared to conventional static format application, realizes dynamic format optimization reflecting the user's emotional state in real time using AI, thereby reducing stress caused by information overload or lack of information and greatly improving the degree of personalization of the format experience. Furthermore, emotion-linked format control does not depend on human subjectivity or experience, and achieves high-precision decision-making and automation by computer, providing technical superiority in both business efficiency and user experience. Applicable fields include sales analysis, inventory management, accounting processing, automatic generation of management dashboards, preparation of audit response materials, and all data formatting operations where emotion or stress affects business efficiency.

The format adjusts the level of detail of the format at the time of formatting based on the importance of the data. For example, a detailed format is provided for important data. For general data, a concise format is provided. The format also adjusts the display order according to the importance of the data. By adjusting the level of detail of the format based on the importance of the data, important data can be preferentially formatted. Specifically, the format optimization system according to the present embodiment assigns an importance score (0.0 to 1.0, managed as meta-information) to each item of the data to be formatted and refers to this score during formatting processing. The system automatically generates a detailed format (full history, related data links, graph display, etc.) for items with high importance scores (management indicators, audit-required items, etc.), and formats only summaries or key values for items with low importance scores (supplementary information, reference values, etc.). The format system sorts the display order of formatted data in descending order of importance score, allowing users to quickly access the most important information. When incorporating AI modules (importance estimation AI or decision-making AI), meta-information of data items (usage frequency, business impact, past reference history, etc.) is input, and importance scores for each item are output. Examples of AI input include item names such as “sales data,” “inventory data,” “customer ID,” and usage frequency such as “100 times,” “50 times,” “10 times,” etc. ; output examples include “sales data” (score 0.95), “inventory data” (score 0.80), “customer ID” (score 0.60), etc. The system dynamically adjusts the level of detail and display order of formatted data based on these scores. As a subsequent process, the user's history of viewing and selecting formatted data is recorded in the database and used for future importance estimation and format optimization. As a technical effect, the format optimization system according to the present embodiment, compared to conventional uniform formatting methods, realizes flexible detail control reflecting the business importance of data, thereby preventing information oversight and misrecognition, and achieving both faster decision-making and improved business efficiency. Applicable fields include management analysis, audit response, sales strategy planning, inventory optimization, and all operations requiring prioritized formatting of important data.

The format estimates a user's emotion and determines the priority order of formatting based on the estimated user's emotion. For example, if the user is nervous, important data is preferentially formatted. If the user is relaxed, detailed data is preferentially formatted. If the user is in a hurry, data that can be formatted quickly is preferentially formatted. By determining the priority order of formatting according to the user's emotion, user convenience is improved. Emotion estimation is realized, for example, by using an emotion engine or generative AI with emotion estimation functionality. Generative AI may include text generation AI (e.g., LLM) or multimodal generative AI, but is not limited to these examples. Specifically, the format priority control system according to the present embodiment collects user input interactions (keystroke speed, mouse movement patterns, voice tone, facial images, etc.) as multidimensional feature vectors (numerical arrays, 100 elements) and inputs them into an emotion estimation AI module (large language model or multimodal emotion recognition model). The system prepares AI input examples such as text “I am nervous,” audio waveform data, and facial images (RGB array, 224×224 pixels). The system receives emotion labels (nervous, relaxed, in a hurry, etc.) and emotion scores (nervousness level 0.80, relaxation level 0.10, etc.) as output from the AI. Output examples include emotion label “nervous,” score 0.80, emotion label “relaxed,” score 0.90, etc. The format priority control system automatically calculates priority scores (importance, formatting speed, level of detail, etc.) for data to be formatted based on the emotion estimation results and dynamically adjusts the order of candidate lists (one-dimensional array, each element includes data ID and priority score). For example, if the nervousness level is high, important data such as “sales” and “inventory” are placed at the top; if the relaxation level is high, detailed data such as “detailed sales breakdown” and “inventory location” are placed at the top; if the user is in a hurry, data that can be formatted quickly such as “simple sales” and “instant inventory” are placed at the top. The AI module (large language model or decision-making AI) takes emotion labels and data lists as input and outputs priority scores (0.95, 0.80, 0.60, etc.) for each data item. The system automatically adjusts the formatting order and UI display methods (emphasized display, color coding, etc.) based on these scores. As a subsequent process, when the user selects or newly formats data, the selection result and emotion estimation value are recorded in the history database and used to improve the accuracy of priority determination in future operations. As a technical effect, the format priority control system according to the present embodiment, compared to conventional static formatting, realizes dynamic prioritization reflecting the user's emotional state in real time, greatly improving formatting efficiency and user satisfaction, and reducing formatting errors and dropout rates. Furthermore, emotion-linked priority control does not depend on human subjectivity or experience, and achieves high-precision decision-making and automation by computer, providing technical superiority in both business efficiency and user experience. Applicable fields include sales analysis, inventory management, accounting processing, automatic generation of management dashboards, preparation of audit response materials, and all data formatting operations where emotion or stress affects business efficiency.

The format adjusts the order of formatting at the time of formatting based on the submission timing of the data. For example, the latest data is preferentially formatted. The format may also reference past data to preferentially format highly relevant data. The format adjusts the display order according to the submission timing of the data. By adjusting the order of formatting based on the submission timing of the data, the latest data can be preferentially formatted. Specifically, the format order control system according to the present embodiment assigns submission timing (timestamp, YYYY/MM/DD HH:MM:SS format) as meta-information to each item of the data to be formatted and refers to this submission timing during formatting processing. The system rearranges formatted data in order of newest submission timing or most relevant timing according to user requests and business scenarios (latest sales, inventory trends over the past three months, etc.). When incorporating AI modules (time-series analysis AI or submission timing weighting AI), the submission timing of data items and business requirements (priority on latest data, reference to past data, etc.) are input, and priority scores (0.95, 0.80, 0.60, etc.) for each data item are output. Examples of AI input include “sales data,” “submission timing: 2024 Jun 1,” “submission timing: 2024 May 1,” and output examples include “2024 Jun. 1” (score 0.95), “2024 May 1” (score 0.80), etc. The system dynamically adjusts the display order and filtering conditions of formatted data based on these scores. As a subsequent process, the user's history of selecting and viewing formatted data is recorded in the database and used to improve the accuracy of order determination in future operations. As a technical effect, the format order control system according to the present embodiment, compared to conventional static formatting methods, realizes dynamic order control reflecting the submission timing of data in real time, enabling rapid acquisition of the latest information and appropriate reference to past data, thereby greatly improving business efficiency and decision-making accuracy. Applicable fields include sales analysis, inventory management, accounting processing, automatic generation of management dashboards, preparation of audit response materials, and all operations requiring prioritized formatting of time-series data.

The system according to the embodiment is not limited to the examples described above, and various modifications are possible, for example, as follows.

The receiving unit can automatically display frequently used item names as candidates by referring to the user's past input history. For example, item names such as sales data and inventory data that the user has entered many times in the past are preferentially displayed. In addition, the receiving unit can predict and propose item names used at specific times based on the user's input history. Thus, the user can efficiently input item names by utilizing past input history.

The searching unit can preferentially search for highly relevant data based on the user's current work status. For example, data related to ongoing projects is preferentially displayed. In addition, data required according to the user's work schedule can also be proposed. Thus, the user can efficiently obtain data according to the current work status.

The extracting unit can preferentially extract important data by considering attribute information of the data submitter. For example, data highly relevant to the submitter's position or department is extracted. In addition, the extracting unit can adjust extraction results by referring to the submitter's past submission history. Thus, data can be efficiently extracted by utilizing attribute information of the data submitter.

The returning unit can preferentially return highly relevant data by considering the geographic distribution of the data. For example, data related to a specific region is preferentially displayed. In addition, the display order of extraction results can be adjusted based on the geographic distribution of the data. Thus, data can be efficiently returned by considering the geographic distribution of the data.

The proposing unit can analyze the user's social media activity and propose relevant item names. For example, the content of the user's social media posts is analyzed and relevant item names are displayed. In addition, highly relevant item names can be proposed based on the user's social media activity history. Thus, item names can be efficiently proposed by utilizing the user's social media activity.

The receiving unit can estimate a user's emotion and adjust the method for receiving item names of the spreadsheet based on the estimated user's emotion. For example, if the user feels stressed, a simple interface is provided and the input procedure is minimized. If the user is relaxed, detailed input options are provided and customizable input methods may also be proposed. Thus, by adjusting the method for receiving item names according to the user's emotion, user convenience can be improved.

The searching unit can estimate a user's emotion and adjust the method of search expression based on the estimated user's emotion. For example, if the user is relaxed, detailed search results are displayed. If the user is in a hurry, concise search results may also be displayed. Thus, by adjusting the method of search expression according to the user's emotion, user convenience can be improved.

The extracting unit can estimate a user's emotion and adjust the method for extracting based on the estimated user's emotion. For example, if the user is relaxed, detailed data is extracted. If the user is in a hurry, concise data may also be extracted. Thus, by adjusting the method for extracting according to the user's emotion, user convenience can be improved.

The returning unit can estimate a user's emotion and adjust the method for returning based on the estimated user's emotion. For example, if the user is relaxed, a detailed method for returning is provided. If the user is in a hurry, a concise method for returning may also be provided. Thus, by adjusting the method for returning according to the user's emotion, user convenience can be improved.

The proposing unit can estimate a user's emotion and adjust the method of proposal expression based on the estimated user's emotion. For example, if the user is relaxed, detailed proposals are made. If the user is in a hurry, concise proposals may also be made. Thus, by adjusting the method of proposal expression according to the user's emotion, user convenience can be improved.

The following is a brief description of the processing flow of Example of the Embodiment.
Step 1: The receiving unit receives item names of Excel. The item names of Excel may include, for example, sales data, inventory data, customer data, etc., but are not limited to these examples. The receiving unit may, for example, read an Excel file and analyze the item names.
Step 2: The searching unit searches a database in a shared folder based on the item names received by the receiving unit. The searching unit may, for example, search the database using the item names as keys and find corresponding data. The searching unit comprises a search algorithm using partial match search or regular expressions. For example, the searching unit may use partial match search to search for data in which part of the item name matches. The searching unit may also use regular expressions to search for data matching a specific pattern.
Step 3: The extracting unit extracts data found by the searching unit. The extracting unit may, for example, filter the corresponding data from the database and extract the necessary data. The extracting unit comprises a method for extracting from the database. For example, the extracting unit may extract data using SQL queries. The extracting unit may also extract data using API calls.
Step 4: The returning unit returns the data extracted by the extracting unit to Excel. The returning unit may, for example, automatically input the extracted data into the corresponding cells of Excel. The returning unit comprises a format for returning the extracted data to Excel. For example, the returning unit may specify the method for formatting the data and the arrangement of cells.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https: //openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned receiving unit, searching unit, extracting unit, and returning unit is implemented by at least one of, for example, the smart device 14 and the data processing apparatus 12. For example, the receiving unit is implemented by a control unit 46A of the smart device 14, reads an Excel file, and analyzes item names. The searching unit is implemented, for example, by a specific processing unit 290 of the data processing apparatus 12, and searches a database in a shared folder based on the item names. The extracting unit is implemented, for example, by the specific processing unit 290 of the data processing apparatus 12, and extracts relevant data. The returning unit is implemented, for example, by the control unit 46A of the smart device 14, and automatically inputs the extracted data into the corresponding cell of Excel. The correspondence between each unit and the apparatus or control unit is not limited to the examples described above, and various modifications are possible.

### Second Embodiment

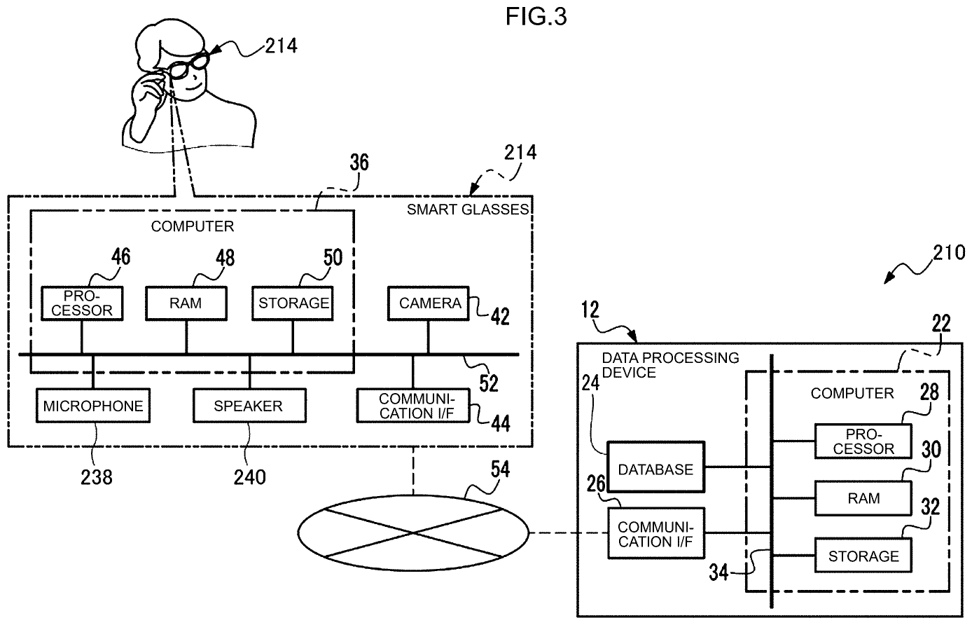

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

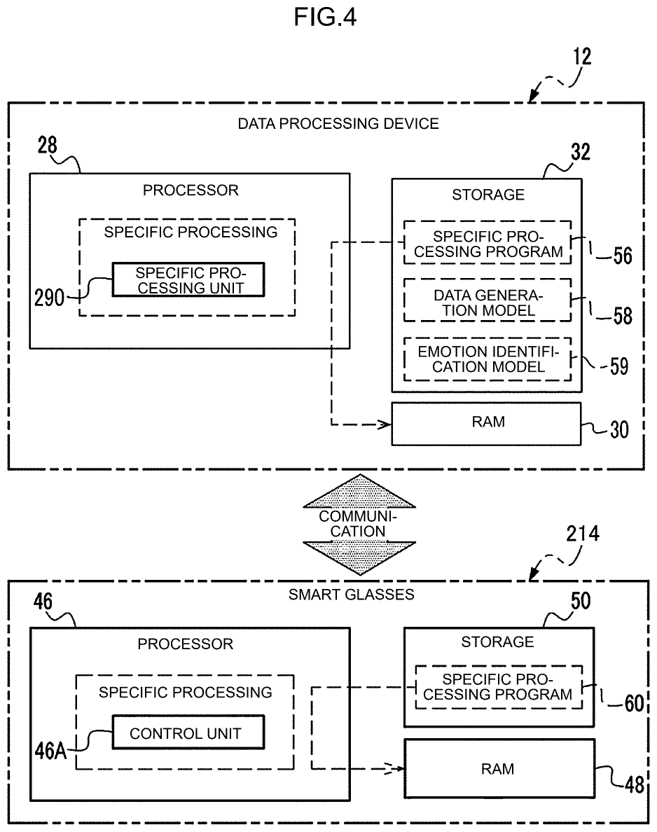

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned receiving unit, searching unit, extracting unit, and returning unit is implemented by at least one of, for example, the smart glasses 214 and the data processing apparatus 12. For example, the receiving unit is implemented by a control unit 46A of the smart glasses 214, reads an Excel file, and analyzes item names. The searching unit is implemented, for example, by a specific processing unit 290 of the data processing apparatus 12, and searches a database in a shared folder based on the item names. The extracting unit is implemented, for example, by the specific processing unit 290 of the data processing apparatus 12, and extracts relevant data. The returning unit is implemented, for example, by the control unit 46A of the smart glasses 214, and automatically inputs the extracted data into the corresponding cell of Excel. The correspondence between each unit and the apparatus or control unit is not limited to the examples described above, and various modifications are possible.

### Third Embodiment

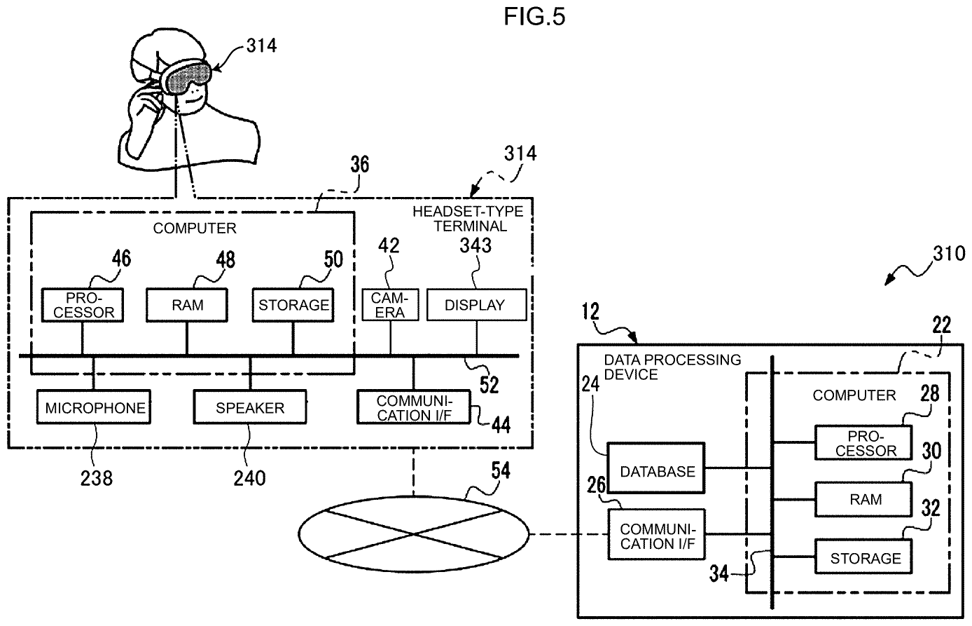

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

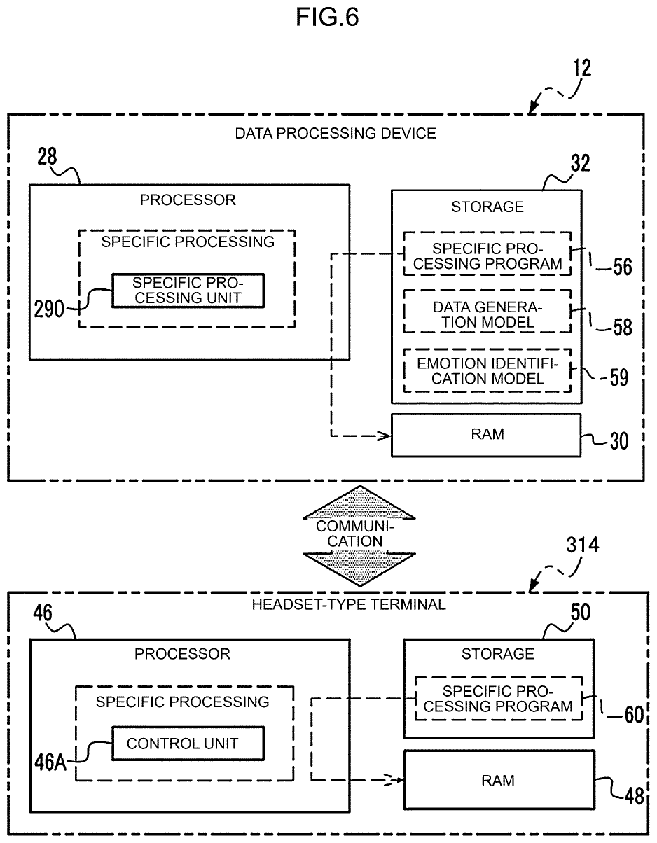

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned receiving unit, searching unit, extracting unit, and returning unit is implemented by at least one of, for example, the headset-type terminal 314 and the data processing apparatus 12. For example, the receiving unit is implemented by a control unit 46A of the headset-type terminal 314, reads an Excel file, and analyzes item names. The searching unit is implemented, for example, by a specific processing unit 290 of the data processing apparatus 12, and searches a database in a shared folder based on the item names. The extracting unit is implemented, for example, by the specific processing unit 290 of the data processing apparatus 12, and extracts relevant data. The returning unit is implemented, for example, by the control unit 46A of the headset-type terminal 314, and automatically inputs the extracted data into the corresponding cell of Excel. The correspondence between each unit and the apparatus or control unit is not limited to the examples described above, and various modifications are possible.

### Fourth Embodiment

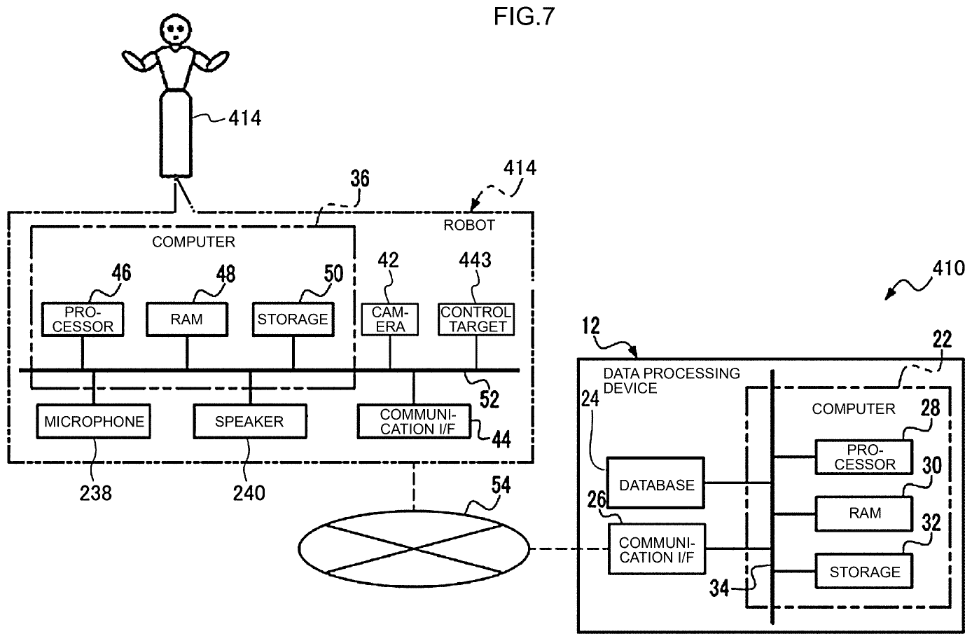

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

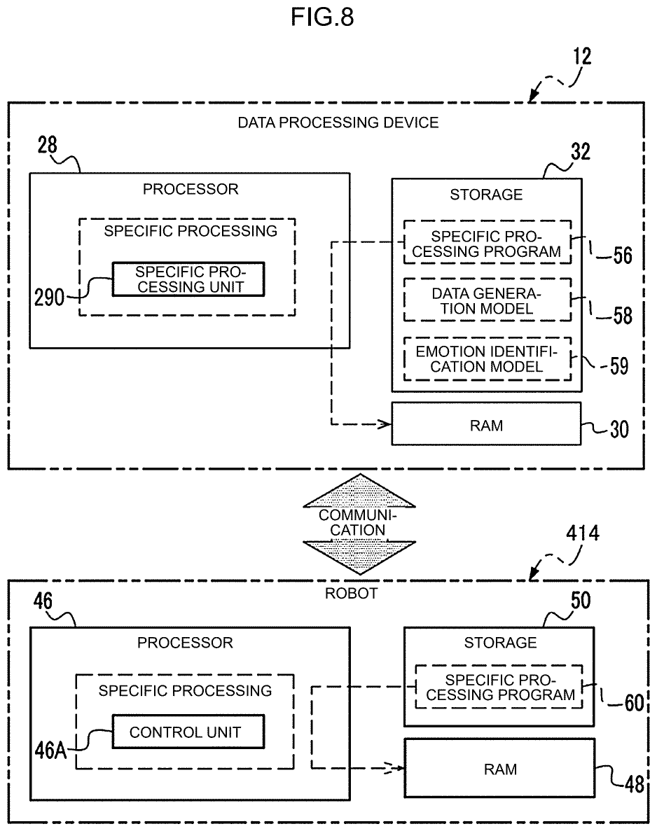

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned receiving unit, searching unit, extracting unit, and returning unit is implemented by at least one of, for example, the robot 414 and the data processing apparatus 12. For example, the receiving unit is implemented by a control unit 46A of the robot 414, reads an Excel file, and analyzes item names. The searching unit is implemented, for example, by a specific processing unit 290 of the data processing apparatus 12, and searches a database in a shared folder based on the item names. The extracting unit is implemented, for example, by the specific processing unit 290 of the data processing apparatus 12, and extracts relevant data. The returning unit is implemented, for example, by the control unit 46A of the robot 414, and automatically inputs the extracted data into the corresponding cell of Excel. The correspondence between each unit and the apparatus or control unit is not limited to the examples described above, and various modifications are possible.

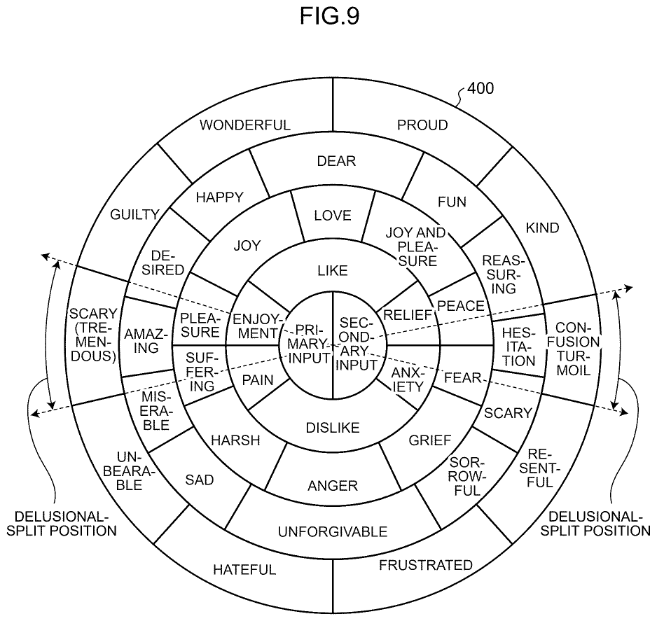

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

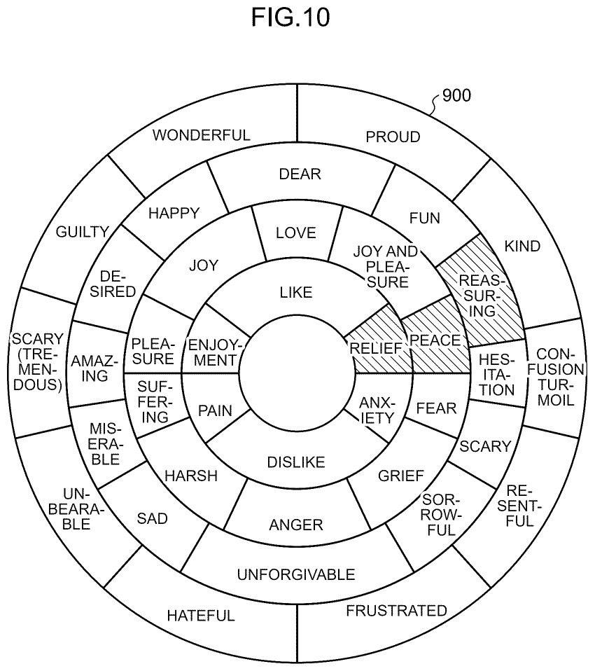

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a receiving unit configured to receive item names of a spreadsheet; a searching unit configured to search a database in a shared folder based on the item names received by the receiving unit; an extracting unit configured to extract data found by the searching unit; and a returning unit configured to return the data extracted by the extracting unit to the spreadsheet.

(Supplementary Note 2) The system according to Supplementary Note 1, wherein the receiving unit comprises a proposing unit configured to propose similar item names when the item name does not match.

(Supplementary Note 3) The system according to Supplementary Note 1, wherein the searching unit comprises a search algorithm using partial match search or regular expressions.

(Supplementary Note 4) The system according to Supplementary Note 1, wherein the extracting unit comprises a method for extracting from the database.

(Supplementary Note 5) The system according to Supplementary Note 1, wherein the returning unit comprises a format for returning the extracted data to Excel.

(Supplementary Note 6) The system according to Supplementary Note 1, wherein the receiving unit is configured to estimate a user's emotion and adjust a method for receiving item names of the spreadsheet based on the estimated user's emotion.

(Supplementary Note 7) The system according to Supplementary Note 1, wherein the receiving unit is configured to select an optimal receiving method by referring to the user's past input history when receiving item names.

(Supplementary Note 8) The system according to Supplementary Note 1, wherein the receiving unit is configured to perform filtering based on the user's current work status when receiving item names.

(Supplementary Note 9) The system according to Supplementary Note 1, wherein the receiving unit is configured to estimate a user's emotion and determine a priority order of item names to be received based on the estimated user's emotion.

(Supplementary Note 10) The system according to Supplementary Note 1, wherein the receiving unit is configured to preferentially receive highly relevant item names by considering the user's geographic location information when receiving item names.

(Supplementary Note 11) The system according to Supplementary Note 1, wherein the receiving unit is configured to analyze the user's social media activity and receive relevant item names when receiving item names.

(Supplementary Note 12) The system according to Supplementary Note 1, wherein the searching unit is configured to estimate a user's emotion and adjust a method of search expression based on the estimated user's emotion.

(Supplementary Note 13) The system according to Supplementary Note 1, wherein the searching unit is configured to adjust a level of search detail based on the importance of the data during searching.

(Supplementary Note 14) The system according to Supplementary Note 1, wherein the searching unit is configured to apply different search algorithms according to the category of the data during searching.

(Supplementary Note 15) The system according to Supplementary Note 1, wherein the searching unit is configured to estimate a user's emotion and adjust a length of search based on the estimated user's emotion.

(Supplementary Note 16) The system according to Supplementary Note 1, wherein the searching unit is configured to determine a priority order of search based on the submission timing of the data during searching.

(Supplementary Note 17) The system according to Supplementary Note 1, wherein the searching unit is configured to adjust a search order based on the relevance of the data during searching.

(Supplementary Note 18) The system according to Supplementary Note 1, wherein the extracting unit is configured to estimate a user's emotion and adjust a method for extracting based on the estimated user's emotion.

(Supplementary Note 19) The system according to Supplementary Note 1, wherein the extracting unit is configured to improve extraction accuracy by considering the interrelationship of the data during extraction.

(Supplementary Note 20) The system according to Supplementary Note 1, wherein the extracting unit is configured to perform extraction by considering attribute information of the data submitter during extraction.

(Supplementary Note 21) The system according to Supplementary Note 1, wherein the extracting unit is configured to estimate a user's emotion and determine a priority order of data to be extracted based on the estimated user's emotion.

(Supplementary Note 22) The system according to Supplementary Note 1, wherein the extracting unit is configured to perform extraction by considering the geographic distribution of the data during extraction.

(Supplementary Note 23) The system according to Supplementary Note 1, wherein the extracting unit is configured to improve extraction accuracy by referring to related literature of the data during extraction.

(Supplementary Note 24) The system according to Supplementary Note 1, wherein the returning unit is configured to estimate a user's emotion and adjust a method for returning based on the estimated user's emotion.

(Supplementary Note 25) The system according to Supplementary Note 1, wherein the returning unit is configured to adjust a level of detail for returning based on the importance of the data during returning.

(Supplementary Note 26) The system according to Supplementary Note 1, wherein the returning unit is configured to apply different returning algorithms according to the category of the data during returning.

(Supplementary Note 27) The system according to Supplementary Note 1, wherein the returning unit is configured to estimate a user's emotion and adjust a length of returning based on the estimated user's emotion.

(Supplementary Note 28) The system according to Supplementary Note 1, wherein the returning unit is configured to determine a priority order for returning based on the submission timing of the data during returning.

(Supplementary Note 29) The system according to Supplementary Note 1, wherein the returning unit is configured to adjust a returning order based on the relevance of the data during returning.

(Supplementary Note 30) The system according to Supplementary Note 2, wherein the proposing unit is configured to estimate a user's emotion and adjust a method of proposal expression based on the estimated user's emotion.

(Supplementary Note 31) The system according to Supplementary Note 2, wherein the proposing unit is configured to adjust a level of proposal detail based on the importance of the item name during proposal.

(Supplementary Note 32) The system according to Supplementary Note 2, wherein the proposing unit is configured to estimate a user's emotion and determine a priority order of proposals based on the estimated user's emotion.

(Supplementary Note 33) The system according to Supplementary Note 2, wherein the proposing unit is configured to adjust a proposal order based on the relevance of the item name during proposal.

(Supplementary Note 34) The system according to Supplementary Note 3, wherein the search algorithm is configured to estimate a user's emotion and select a search algorithm based on the estimated user's emotion.

(Supplementary Note 35) The system according to Supplementary Note 3, wherein the search algorithm is configured to optimize the search algorithm by referring to past search data during searching.

(Supplementary Note 36) The system according to Supplementary Note 3, wherein the search algorithm is configured to estimate a user's emotion and adjust a frequency of the search algorithm based on the estimated user's emotion.

(Supplementary Note 37) The system according to Supplementary Note 3, wherein the search algorithm is configured to weight the search algorithm based on the submission timing of the data during searching.

(Supplementary Note 38) The system according to Supplementary Note 1, wherein the method for extracting is configured to estimate a user's emotion and adjust the method for extracting based on the estimated user's emotion.

(Supplementary Note 39) The system according to Supplementary Note 1, wherein the method for extracting is configured to optimize the method for extracting by referring to past extraction data during extraction.

(Supplementary Note 40) The system according to Supplementary Note 1, wherein the method for extracting is configured to estimate a user's emotion and adjust a frequency of the method for extracting based on the estimated user's emotion.

(Supplementary Note 41) The system according to Supplementary Note 1, wherein the method for extracting is configured to weight the method for extracting based on the submission timing of the data during extraction.

(Supplementary Note 42) The system according to Supplementary Note 1, wherein the format is configured to estimate a user's emotion and adjust a method of format expression based on the estimated user's emotion.

(Supplementary Note 43) The system according to Supplementary Note 1, wherein the format is configured to adjust a level of format detail based on the importance of the data during formatting.

(Supplementary Note 44) The system according to Supplementary Note 1, wherein the format is configured to estimate a user's emotion and determine a priority order of formats based on the estimated user's emotion.

(Supplementary Note 45) The system according to Supplementary Note 1, wherein the format is configured to adjust a format order based on the submission timing of the data during formatting.

What is claimed is:

1. A system comprising:
circuitry configured to:
receive, from a client terminal via a communication interface and a packet-switched network, spreadsheet data comprising item name strings extracted from cells of a spreadsheet file;
search a database storing structured records by applying a search algorithm to the item name strings, the search algorithm comprising at least one of a partial match search, a regular expression search, or a key-based index lookup, to identify record identifiers corresponding to matching records;
extract data from the database based on the identified record identifiers; and
transmit the extracted data to the client terminal via the communication interface and the packet-switched network, the extracted data causing the client terminal to populate corresponding cells of the spreadsheet file with the extracted data.

2. The system according to claim 1, wherein the circuitry is further configured to calculate a string similarity score between each item name string and a plurality of candidate item names stored in the database, and to propose, to the client terminal via the communication interface, a candidate item name having a highest string similarity score when no exact match is found.

3. The system according to claim 2, wherein the string similarity score is calculated using at least one of a Levenshtein distance, a Jaccard coefficient, or a cosine similarity.

4. The system according to claim 1, wherein the search algorithm comprises a LIKE operator applied to a relational database management system or a regular expression engine applied to the item name strings.

5. The system according to claim 1, wherein the circuitry is further configured to extract the data by issuing at least one of an SQL query or a RESTful API call to the database based on the identified record identifiers.

6. The system according to claim 1, wherein the circuitry is further configured to perform post-processing on the extracted data comprising at least one of data type conversion, missing value completion, or duplicate elimination before transmitting the extracted data to the client terminal.

7. The system according to claim 1, wherein the circuitry is further configured to generate a cell address conversion table mapping each item of the extracted data to a corresponding cell position in the spreadsheet file, and to format the extracted data according to a specified format before transmitting.

8. The system according to claim 1, further comprising a memory storing an emotion identification model, wherein the circuitry is further configured to estimate an emotion of a user by applying the emotion identification model to sensor data received from the client terminal, and to adjust a method of receiving the spreadsheet data based on the estimated emotion.

9. The system according to claim 8, wherein the circuitry is further configured to provide a simplified interface when the estimated emotion indicates stress, and to provide detailed input options when the estimated emotion indicates relaxation.

10. The system according to claim 1, wherein the circuitry is further configured to analyze a past input history of the user stored in a database to identify frequently used item names, and to preferentially display the frequently used item names as candidates to the client terminal.

11. The system according to claim 1, wherein the circuitry is further configured to receive work status data from the client terminal, the work status data comprising at least one of an ongoing project identifier or a task category, and to filter the item name strings based on the work status data.

12. The system according to claim 1, wherein the circuitry is further configured to receive geographic location information from the client terminal, and to preferentially search for records in the database associated with a geographic region corresponding to the geographic location information.

13. The system according to claim 1, further comprising a memory storing an emotion identification model, wherein the circuitry is further configured to estimate an emotion of a user by applying the emotion identification model to sensor data received from the client terminal, and to adjust a level of detail of search results based on the estimated emotion, such that detailed search results are provided when the estimated emotion indicates relaxation, and concise search results are provided when the estimated emotion indicates urgency.

14. The system according to claim 1, wherein the circuitry is further configured to assign an importance score to each item of the extracted data, and to adjust a level of detail of the extracted data transmitted to the client terminal based on the importance score.

15. The system according to claim 1, wherein the circuitry is further configured to apply different search algorithms according to a category of the item name strings, such that for item name strings in a sales category, a time-series search algorithm is applied, and for item name strings in an inventory category, a location-based search algorithm is applied.

16. The system according to claim 1, wherein the circuitry is further configured to determine a priority order of search results based on a submission timing associated with the structured records, such that records having a more recent submission timing are displayed with a higher priority.

17. The system according to claim 1, wherein the circuitry is further configured to perform cross-database searches across a plurality of databases comprising at least two of a sales database, an inventory database, or a customer database, and to aggregate results from the plurality of databases.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor;
a random-access memory;
a memory storing a data generation model obtained by deep learning on a neural network, and an emotion identification model;
a database storing structured records; and
circuitry configured to:
receive, from the client terminal via the communication interface, spreadsheet data comprising item name strings extracted from cells of a spreadsheet file;
search the database by applying a search algorithm to the item name strings, the search algorithm comprising at least one of a partial match search using a LIKE operator, a regular expression search, or a key-based index lookup using a trie structure, to identify record identifiers corresponding to matching records;
calculate, when no exact match is found, a string similarity score between each item name string and candidate item names in the database using at least one of a Levenshtein distance, a Jaccard coefficient, or a cosine similarity, and transmit proposed candidate item names to the client terminal;
extract data from the database based on the identified record identifiers by issuing at least one of an SQL query or a RESTful API call;
estimate an emotion of a user by applying the emotion identification model to at least one of voice data captured by the microphone or image data captured by the camera;
adjust at least one of a level of detail or a format of the extracted data based on the estimated emotion; and
transmit the extracted data to the client terminal via the communication interface, the extracted data causing the client terminal to populate corresponding cells of the spreadsheet file and to present the extracted data to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a database storing structured records, and a memory, the method comprising:
receiving, from a client terminal via the communication interface and a packet-switched network, spreadsheet data comprising item name strings extracted from cells of a spreadsheet file;
searching the database by applying a search algorithm to the item name strings, the search algorithm comprising at least one of a partial match search, a regular expression search, or a key-based index lookup, to identify record identifiers corresponding to matching records;
extracting data from the database based on the identified record identifiers; and
transmitting the extracted data to the client terminal via the communication interface and the packet-switched network, the extracted data causing the client terminal to populate corresponding cells of the spreadsheet file with the extracted data.
